(19) United States
(12) Patent Application Publication
(10) Pub. No.: US 2019/0302422 A1
(43) Pub. Date: Oct. 3, 2019

(54) OPTICAL IMAGE CAPTURING SYSTEM

(71) Applicant: ABILITY OPTO-ELECTRONICS TECHNOLOGY CO. LTD., Taichung City (TW)

(72) Inventors: Yeong-Ming CHANG, Taichung City (TW); Chien-Hsun LAI, Taichung City (TW); Yao-Wei LIU, Taichung City (TW)

(21) Appl. No.: 16/037,584

(22) Filed: Jul. 17, 2018

(30) Foreign Application Priority Data
Mar. 27, 2018 (TW) 107110558

(51) Int. Cl. G02B 13/00; G02B 9/62

(52) U.S. Cl. CPC G02B 13/0045; G02B 9/62

(57) ABSTRACT

An optical image capturing system is provided. In order from an object side to an image side, the optical image capturing system includes a first lens, a second lens, a third lens, a fourth lens, a fifth lens and a sixth lens. At least one of lens among the first lens through the fifth lens has positive refractive power. The sixth lens has negative refractive power, and an image side and an object side thereof are aspheric wherein at least one of the image side and the object side thereof has an inflection point. All of the six lenses have refractive power. When meeting some certain conditions, the optical image capturing system may have an outstanding light-gathering ability and adjustment ability about the optical path to elevate the image quality.

### CROSS-REFERENCE TO RELATED APPLICATION

This application claims the benefit of Taiwan Patent Application No. 107110558, filed on Mar. 27, 2018, in the Taiwan Intellectual Property Office, the disclosure of which is incorporated herein in its entirety by reference.

### BACKGROUND OF THE INVENTION

### 1. Field of the Invention

The present invention relates to an optical image capturing system, and more particularly to a compact optical image capturing system which can apply to electronic products.

### 2. Description of the Related Art

In recent years, with the rise of portable electronic devices having camera functionalities, the demand for an optical image capturing system has gradually been raised. The image sensing device of the ordinary photographing camera is commonly selected from a charge coupled device (CCD) or a complementary metal-oxide semiconductor sensor (CMOS Sensor). Also, as advanced semiconductor manufacturing technology enables the minimization of the pixel size of the image sensing device, the development of the optical image capturing system has gravitated towards the field of high pixels. Therefore, the requirement for high image quality has been rapidly increasing.

The traditional optical image capturing system of a portable electronic device comes with different designs, including a four-lens or a fifth-lens design. However, since the pixel density has continuously increased, more end-users are demanding a large aperture for such functionalities as micro filming and night view. The optical image capturing system of prior art cannot meet these high requirements and requires a higher order camera lens module.

Therefore, how to effectively increase quantity of incoming light of the optical lenses, and further improve image quality for the image formation, has become an important issue.

### SUMMARY OF THE INVENTION

The aspect of embodiment of the present invention directs to an optical image capturing system and an optical image capturing lens which use combination of refractive power, convex and concave surfaces of six-piece optical lenses (the convex or concave surface in the present invention denotes the change of geometrical shape of an object side or an image side of each lens with different height from an optical axis) to increase the quantity of incoming light of the optical image capturing system, and to improve image quality for image formation, so as to be applied to minimized electronic products.

The term and the definition to the lens parameter in the embodiment of the present invention are shown as below for further reference.

The Lens Parameters Related to the Length or the Height

The maximum height for image formation of the optical image capturing system is denoted by HOI. The height of the optical image capturing system is denoted by HOS. The distance from the object side of the first lens to the image side of the sixth lens is denoted by InTL. The distance from an aperture stop (aperture) to an image plane is denoted by InS. The distance from the first lens to the second lens is denoted by In12 (instance). The central thickness of the first lens of the optical image capturing system on the optical axis is denoted by TP1 (instance).

The Lens Parameters Related to the Material

The coefficient of dispersion of the first lens in the optical image capturing system is denoted by NA1 (instance). The refractive index of the first lens is denoted by Nd1 (instance).

The Lens Parameters Related to the Angle of View

The angle of view is denoted by AF. Half of the angle of view is denoted by HAF. The major light angle is denoted by MRA.

The Lens Parameters Related to the Exit/Entrance Pupil

The entrance pupil diameter of the optical image capturing system is denoted by HEP. A maximum effective half diameter (EHD) of any surface of the single lens is a perpendicular distance between an optical axis and an intersection point on the surface where the incident light with a maximum angle of view of the system passing the edge of the entrance pupil. For example, the maximum effective half diameter of the object side of the first lens may be expressed as EHD 11. The maximum effective half diameter of the image side of the first lens may be expressed as EHD 12. The maximum effective half diameter of the object side of the second lens may be expressed as EHD 21. The maximum effective half diameter of the image side of the second lens may be expressed as EHD 22. The maximum effective half diameters of any surfaces of other lenses in the optical image capturing system are expressed in a similar way.

The Lens Parameters Related to the Depth

The horizontal distance parallel to an optical axis from a maximum effective half diameter position of the object side of the sixth to an intersection point where the object side of the sixth lens crosses the optical axis is denoted by InRS61 (a depth of the maximum effective half diameter). The horizontal distance parallel to an optical axis from a maximum effective half diameter position the image side of the sixth lens to an intersection point where the object side of the sixth lens crosses the optical axis on the image side of the sixth lens is denoted by InRS62 (the depth of the maximum effective half diameter). The depths of the maximum effective half diameters (sinkage values) of object side and image side of other lenses are denoted in a similar way.

The Lens Parameter Related to the Lenseshape

The critical point C is a tangent point on a surface of a specific lens. The tangent point is tangent to a plane perpendicular to the optical axis except that an intersection point which crosses the optical axis on the specific surface of the lens. In accordance, the distance perpendicular to the optical axis between a critical point C51 on the object side of the fifth lens and the optical axis is HVT51 (instance). The distance perpendicular to the optical axis between a critical point C52 on the image side of the fifth lens and the optical axis is HVT52 (instance). The distance perpendicular to the optical axis between a critical point C61 on the object side of the sixth lens and the optical axis is HVT61 (instance). The distance perpendicular to the optical axis between a critical point C62 on the image side of the sixth lens and the optical axis is HVT62 (instance). The distances perpendicular to the optical axis between critical points on the object side or the image side of other lenses and the optical axis are denoted in a similar way as described above.

The object side of the sixth lens has one inflection point IF611 which is the first nearest to the optical axis. The sinkage value of the inflection point IF611 is denoted by SGI611. SGI611 is a horizontal distance parallel to the optical axis, which is from an intersection point where the object side of the sixth lens crosses the optical axis to the inflection point on the object side of the sixth lens that is the first nearest to the optical axis. The distance perpendicular to the optical axis between the inflection point IF611 and the optical axis is HIF611 (instance). The image side of the sixth lens has one inflection point IF621 which is the first nearest to the optical axis and the sinkage value of the inflection point IF621 is denoted by SGI621 (instance). SGI621 is a horizontal distance parallel to the optical axis, which is from the intersection point where the image side of the sixth lens crosses the optical axis to the inflection point on the image side of the sixth lens that is the first nearest to the optical axis. The distance perpendicular to the optical axis between the inflection point IF621 and the optical axis is HIF621 (instance).

The object side of the sixth lens has one inflection point IF612 which is the second nearest to the optical axis and the sinkage value of the inflection point IF612 is denoted by SGI612 (instance). SGI612 is a horizontal distance parallel to the optical axis, which is from an intersection point where the object side of the sixth lens crosses the optical axis to the inflection point on the object side of the sixth lens that is the second nearest to the optical axis. The distance perpendicular to the optical axis between the inflection point IF612 and the optical axis is HIF612 (instance). The image side of the sixth lens has one inflection point IF622 which is the second nearest to the optical axis and the sinkage value of the inflection point IF622 is denoted by SGI622 (instance). SGI622 is a horizontal distance parallel to the optical axis, which is from an intersection point where the image side of the sixth lens crosses the optical axis to the inflection point on the image side of the sixth lens that is the second nearest to the optical axis. The distance perpendicular to the optical axis between the inflection point IF622 and the optical axis is HIF622 (instance).

The object side of the sixth lens has one inflection point IF613 which is the third nearest to the optical axis and the sinkage value of the inflection point IF613 is denoted by SGI613 (instance). SGI613 is a horizontal distance parallel to the optical axis, which is from an intersection point where the object side of the sixth lens crosses the optical axis to the inflection point on the object side of the sixth lens that is the third nearest to the optical axis. A distance perpendicular to the optical axis between the inflection point IF613 and the optical axis is HIF613 (instance). The image side of the sixth lens has one inflection point IF623 which is the third nearest to the optical axis and the sinkage value of the inflection point IF623 is denoted by SGI623 (instance). SGI623 is a horizontal distance parallel to the optical axis, which is from an intersection point where the image side of the sixth lens crosses the optical axis to the inflection point on the image side of the sixth lens that is the third nearest to the optical axis. The distance perpendicular to the optical axis between the inflection point IF623 and the optical axis is HIF623 (instance).

The object side of the sixth lens has one inflection point IF614 which is the fourth nearest to the optical axis and the sinkage value of the inflection point IF614 is denoted by SGI614 (instance). SGI614 is a horizontal distance parallel to the optical axis, which is from an intersection point where the object side of the sixth lens crosses the optical axis to the inflection point on the object side of the sixth lens that is the fourth nearest to the optical axis. The distance perpendicular to the optical axis between the inflection point IF614 and the optical axis is HIF614 (instance). The image side of the sixth lens has one inflection point IF624 which is the fourth nearest to the optical axis and the sinkage value of the inflection point IF624 is denoted by SGI624 (instance). SGI624 is a horizontal distance parallel to the optical axis, which is from an intersection point where the image side of the sixth lens crosses the optical axis to the inflection point on the image side of the sixth lens that is the fourth nearest to the optical axis. The distance perpendicular to the optical axis between the inflection point IF624 and the optical axis is HIF624 (instance).

The inflection points on the object sides or the image side of the other lenses and the distances perpendicular to the optical axis thereof or the sinkage values thereof are denoted in a similar way described above.

The Lens Parameters Related to an Aberration

Optical distortion for image formation in the optical image capturing system is denoted by ODT. TV distortion for image formation in the optical image capturing system is denoted by TDT. Further, the degree of aberration offset within a range of 50% to 100% of the field of view of the image can be further limited. An offset of the spherical aberration is denoted by DFS. An offset of the coma aberration is denoted by DFC.

The characteristic diagram of modulation transfer function of the optical image capturing system is used for testing and evaluating the contrast ratio and the sharpness ratio of the image. The vertical coordinate axis of the characteristic diagram of modulation transfer function indicates a contrast transfer rate (with values from 0 to 1). The horizontal coordinate axis indicates a spatial frequency (cycles/mm; lp/mm; line pairs per mm) Theoretically, an ideal image capturing system can clearly and distinctly show the line contrast of a photographed object. However, the values of the contrast transfer rate at the vertical coordinate axis are smaller than 1 in the actual optical image capturing system. In addition, to achieve a fine degree of recovery in the edge region of the image is generally more difficult than in the central region of the image. The contrast transfer rates (MTF values) with spatial frequencies of 55 cycles/mm at the optical axis, 0.3 field of view and 0.7 field of view of visible light spectrum on the image plane may be expressed respectively as MTFE0, MTFE3 and MTFE7. The contrast transfer rates (MTF values) with spatial frequencies of 110 cycles/mm at the optical axis, 0.3 field of view, and 0.7 field of view of visible light spectrum on the image plane may be respectively expressed as MTFQ0, MTFQ3 and MTFQ7. The contrast transfer rates (MTF values) with spatial frequencies of 220 cycles/mm at the optical axis, 0.3 field of view, and 0.7 field of view of visible light spectrum on the image plane may be respectively expressed as MTFH0, MTFH3 and MTFH7. The contrast transfer rates (MTF values) with spatial frequencies of 440 cycles/mm at the optical axis, 0.3 field of view, and 0.7 field of view of visible light spectrum on the image plane may be respectively expressed as MTF0, MTF3 and MTF7. The three fields of view described above are representative to the center, the internal field of view and the external field of view of the lens. Therefore, the three fields of view described above may be used to evaluate whether the performance of the specific optical image capturing system is excellent. If the design of the optical image capturing system corresponds to a sensing device which pixel size is below and equal to 1.12 micrometers, the quarter spatial frequencies, the half spatial frequencies (half frequencies) and the full spatial frequencies (full frequencies) of the characteristic diagram of modulation transfer function are respectively at least 110 cycles/mm, 220 cycles/mm and 440 cycles/mm.

If an optical image capturing system needs to satisfy conditions with images of the infrared spectrum and the visible spectrum simultaneously, such as the requirements for night vision in low light, the used wavelength may be 850 nm or 800 nm. Since the main function is to recognize the shape of an object formed in a black-and-white environment, high resolution is unnecessary and thus the spatial frequency which is less than 110 cycles/mm may be selected to evaluate the performance of the specific optical image capturing system on the infrared light spectrum. When the operation wavelength 850 nm is focused on the image plane, the contrast transfer rates (MTF values) with a spatial frequency of 55 cycles/mm where the images are at the optical axis, 0.3 field of view and 0.7 field of view may be respectively expressed as MTFI0, MTFI3 and MTFI7. However, because the difference between the infrared wavelength of 850 nm or 800 nm and the general visible light wavelength is large, the optical image capturing system which not only has to focus on the visible light and the infrared light (dual-mode) but also has to achieve a certain function in the visible light and the infrared light respectively has a significant difficulty in design.

The present invention provides an optical image capturing system, an object side or an image side of the sixth lens may have inflection points, such that the angle of incidence from each field of view to the sixth lens can be adjusted effectively and the optical distortion and the TV distortion can be corrected as well. Furthermore, the surfaces of the sixth lens may have a better optical path adjusting ability to acquire better image quality.

The present invention provides an optical image capturing system, in order from an object side to an image side, including a first lens, a second lens, a third lens, a fourth lens, a fifth lens, a sixth lens and an image plane. The first lens has refractive power. Both the object side and the image side of the sixth lens may be aspheric. Focal lengths of the first lens through sixth lens are respectively f1, f2, f3, f4, f5 and f6. The focal length of the optical image capturing system is f. The maximum height for image formation on the image plane in the optical image capturing system is denoted by HOI. At least one lens among the six lenses is made of glass. The entrance pupil diameter of the optical image capturing system is HEP. The distance on an optical axis from an object side of the first lens to the image plane is HOS. The distance on the optical axis from the object side of the first lens to the image side of the sixth lens is InTL. A half maximum angle of view of the optical image capturing system is HAF. The horizontal distance parallel to the optical axis from a coordinate point on the object side of the first lens at height of ½ HEP to the image plane is expressed as ETL. The horizontal distance parallel to the optical axis from the coordinate point on the object side of the first lens at height of ½ HEP to a coordinate point on the image side of the sixth lens at height of ½ HEP is expressed as EIN. The conditions as follows are satisfied: 1.0≤f/HEP≤10.0; deg<HAF≤150 deg and 0.2≤EIN/ETL<1.

The present invention provides another optical image capturing system, in order from an object side to an image side, including a first lens, a second lens, a third lens, a fourth lens, a fifth lens, a sixth lens and an image plane. The first lens has negative refractive power. The object side of the first lens adjacent to the optical axis may be convex. The second lens has refractive power. The third lens has refractive power. The fourth lens has refractive power. The fifth lens has refractive power. The sixth lens has refractive power. Both the object side and image side of the sixth lens may be aspheric. Focal lengths of the first lens through the sixth lens are respectively f1, f2, f3, f4, f5 and f6. The focal length of the optical image capturing system is f. The maximum height for image formation on the image plane perpendicular to the optical axis in the optical image capturing system is denoted by HOI. At least two lenses among the first lens to the sixth lens are made of glass. At least one lens among the second lens through the sixth lens has positive refractive power. The entrance pupil diameter of the optical image capturing system is HEP. The distance on an optical axis from an object side of the first lens to the image plane is HOS. A distance on an optical axis from the object side of the first lens to the image side of the sixth lens is InTL. A half maximum angle of view of the optical image capturing system is HAF. The horizontal distance parallel to the optical axis from a coordinate point on the object side of the first lens at height of ½ HEP to the image plane is expressed as ETL. The horizontal distance parallel to the optical axis from the coordinate point on the object side of the first lens at height of ½ HEP to a coordinate point on the image side of the sixth lens at height of ½ HEP is expressed as EIN. The following conditions are satisfied: 1.0≤f/HEP≤10.0, 0 deg<HAF≤150 deg and 0.2≤EIN/ETL<1.

The present invention provides another optical image capturing system, in order from an object side to an image side, including a first lens, a second lens, a third lens, a fourth lens, a fifth lens, a sixth lens and an image plane. Wherein the optical image capturing system consists of the six lenses with refractive power. The first lens has negative refractive power. The second lens has negative refractive power. The third lens has refractive power. The fourth lens has refractive power. The fifth lens has refractive power. The sixth lens has refractive power. Focal lengths of the first lens through the sixth lens are respectively f1, f2, f3, f4, f5 and f6. The focal length of the optical image capturing system is f. The maximum height for image formation on the image plane perpendicular to the optical axis in the optical image capturing system is denoted by HOI. At least one lens among the first lens through the sixth lens is made of glass. At least one lens among the first lens through the sixth lens has respectively at least one inflection point on at least one surface thereof. The entrance pupil diameter of the optical image capturing system is HEP. The half maximum angle of view of the optical image capturing system is HAF. The distance on an optical axis from an object side of the first lens to the image plane is HOS. The distance on the optical axis from the object side of the first lens to the image side of the sixth lens is InTL. The horizontal distance parallel to the optical axis from a coordinate point on the object side of the first lens at height of ½ HEP to the image plane is expressed as ETL. The horizontal distance parallel to the optical axis from the coordinate point on the object side of the first lens at height of ½ HEP to a coordinate point on the image side of the sixth lens at height of ½ HEP is expressed as EIN. The conditions as follows are satisfied: 1.0≤f/HEP≤10.0; deg<HAF≤150 deg and 0.2≤EIN/ETL<1.

The thickness of a single lens at a height of ½ entrance pupil diameter (HEP) particularly affects the corrected aberration of common area of each field of view of light and the capability of correcting the optical path difference between each field of view of light in the scope of ½ entrance pupil diameter (HEP). The capability of aberration correction is enhanced if the thickness of the lens becomes greater, but the difficulty for manufacturing is also increased at the same time. Therefore, the thickness of a single lens at the height of ½ entrance pupil diameter (HEP) needs to be controlled. The ratio relationship (ETP/TP) between the thickness (ETP) of the lens at a height of ½ entrance pupil diameter (HEP) and the thickness (TP) of the lens on the optical axis needs to be controlled in particular. For example, the thickness of the first lens at a height of ½ entrance pupil diameter (HEP) may be expressed as ETP1. The thickness of the second lens at a height of ½ entrance pupil diameter (HEP) may be expressed as ETP2. The thicknesses of other lenses at a height of ½ entrance pupil diameter (HEP) in the optical image capturing system are expressed in a similar way. The sum of ETP1 to ETP6 described above may be expressed as SETP. The embodiments of the present invention may satisfy the following relationship: 0.3≤SETP/EIN<1.

In order to achieve a balance between enhancing the capability of aberration correction and reducing the difficulty for manufacturing, the ratio relationship (ETP/TP) between the thickness (ETP) of the lens at the height of ½ entrance pupil diameter (HEP) and the thickness (TP) of the lens on the optical axis needs to be controlled in particular. For example, the thickness of the first lens at the height of ½ entrance pupil diameter (HEP) may be expressed as ETP1. The thickness of the first lens on the optical axis may be expressed as TP1. The ratio between ETP1 and TP1 may be expressed as ETP1/TP1. The thickness of the second lens at the height of ½ entrance pupil diameter (HEP) may be expressed as ETP2. The thickness of the second lens on the optical axis may be expressed as TP2. The ratio between ETP2 and TP2 may be expressed as ETP2/TP2. The ratio relationships between the thicknesses of other lenses at height of ½ entrance pupil diameter (HEP) and the thicknesses (TP) of the lens on the optical axis lens in the optical image capturing system are expressed in a similar way. The embodiments of the present invention may satisfy the following relationship: 0.2≤ETP/TP≤3.

The horizontal distance between two adjacent lenses at height of ½ entrance pupil diameter (HEP) may be expressed as ED. The horizontal distance (ED) described above is parallel to the optical axis of the optical image capturing system and particularly affects the corrected aberration of common area of each field of view of light and the capability of correcting the optical path difference between each field of view of light at the position of ½ entrance pupil diameter (HEP). The capability of aberration correction may be enhanced if the horizontal distance becomes greater, but the difficulty for manufacturing is also increased and the degree of ‘miniaturization’ to the length of the optical image capturing system is restricted. Therefore, the horizontal distance (ED) between two specific adjacent lens at the height of ½ entrance pupil diameter (HEP) must be controlled.

In order to achieve a balance between enhancing the capability of correcting aberration and reducing the difficulty for ‘minimization’ to the length of the optical image capturing system, the ratio relationship (ED/IN) of the horizontal distance (ED) between the two adjacent lenses at height of ½ entrance pupil diameter (HEP) to the horizontal distance (IN) between the two adjacent lenses on the optical axis particularly needs to be controlled. For example, the horizontal distance between the first lens and the second lens at height of ½ entrance pupil diameter (HEP) may be expressed as ED12. The horizontal distance on the optical axis between the first lens and the second lens may be expressed as IN12. The ratio between ED12 and IN12 may be expressed as ED12/IN12. The horizontal distance between the second lens and the third lens at height of ½ entrance pupil diameter (HEP) may be expressed as ED23. The horizontal distance on the optical axis between the second lens and the third lens may be expressed as IN23. The ratio between ED23 and IN23 may be expressed as ED23/IN23. The ratio relationships of the horizontal distances between other two adjacent lenses in the optical image capturing system at height of ½ entrance pupil diameter (HEP) to the horizontal distances on the optical axis between the two adjacent lenses are expressed in a similar way.

The horizontal distance parallel to the optical axis from a coordinate point on the image side of the sixth lens at height ½ HEP to the image plane may be expressed as EBL. The horizontal distance parallel to the optical axis from an intersection point where the image side of the sixth lens crosses the optical axis to the image plane may be expressed as BL. The embodiments of the present invention are able to achieve a balance between enhancing the capability of aberration correction and reserving space to accommodate other optical lenses and the following condition may be satisfied: 0.2≤EBL/BL≤1.1. The optical image capturing system may further include a light filtering element. The light filtering is located between the sixth lens and the image plane. The distance parallel to the optical axis from a coordinate point on the image side of the sixth lens at height of ½ HEP to the light filtering may be expressed as EIR. The distance parallel to the optical axis from an intersection point where the image side of the sixth lens crosses the optical axis to the light filtering may be expressed as PIR. The embodiments of the present invention may satisfy the following condition: 0.1≤EIR/PIR≤1.1.

The height of optical image capturing system (HOS) may be reduced to achieve the minimization of the optical image capturing system when the absolute value of f1 is larger than the absolute value of f6 (|f1|>|f6|).

When the relationship |f2|+f3|+|f4|+|f5| and |f1|+|f6| are satisfied, at least one of the second lens through fifth lens may have weak positive refractive power or weak negative refractive power. The weak refractive power indicates that an absolute value of the focal length of a specific lens is greater than 10. When at least one of the second lens through the fifth lens has weak positive refractive power, the positive refractive power of the first lens can be shared effectively, such that the unnecessary aberration will not appear too early. On the contrary, when at least one of the second lens and fifth lens has weak negative refractive power, the aberration of the optical image capturing system can be corrected and fine-tuned.

In addition, the sixth lens may have negative refractive power, and the image side of the sixth lens may be a concave surface. Hereby, this configuration is beneficial to shorten the back focal length of the optical image capturing system in order to keep the miniaturization of the optical image capturing system. Moreover, at least one surface of the sixth lens may possess at least one inflection point which is capable of effectively reducing the incident angle of the off-axis rays and may further correct the off-axis aberration.

### BRIEF DESCRIPTION OF THE DRAWINGS

The detailed structure, operating principles and effects of the present invention will now be described in more details hereinafter with reference to the accompanying drawings that show various embodiments of the present invention as follows.

FIG. 1A is a schematic view of the optical image capturing system according to the first embodiment of the present application.

FIG. 1B is a curve diagram illustrating the spherical aberration, astigmatism and optical distortion of the optical image capturing system in order from left to right according to the first embodiment of the present invention.

FIG. 1C is a characteristic diagram of modulation transfer of visible light spectrum for the optical image capturing system according to the first embodiment of the present invention.

FIG. 2A is a schematic view of the optical image capturing system according to the second embodiment of the present application.

FIG. 2B is a curve diagram illustrating the spherical aberration, astigmatism and optical distortion of the optical image capturing system in order from left to right according to the second embodiment of the present invention.

FIG. 2C is a characteristic diagram of modulation transfer of visible light spectrum for the optical image capturing system according to the second embodiment of the present invention.

FIG. 3A is a schematic view of the optical image capturing system according to the third embodiment of the present application.

FIG. 3B a curve diagram illustrating the spherical aberration, astigmatism and optical distortion of the optical image capturing system in order from left to right according to the third embodiment of the present invention.

FIG. 3C is a characteristic diagram of modulation transfer of visible light spectrum for the optical image capturing system according to the third embodiment of the present invention.

FIG. 4A is a schematic view of the optical image capturing system according to the fourth embodiment of the present application.

FIG. 4B is a curve diagram illustrating the spherical aberration, astigmatism and optical distortion of the optical image capturing system in order from left to right according to the fourth embodiment of the present invention.

FIG. 4C is a characteristic diagram of modulation transfer of visible light spectrum for the optical image capturing system according to the fourth embodiment of the present invention.

FIG. 5A is a schematic view of the optical image capturing system according to the fifth embodiment of the present application.

FIG. 5B is a curve diagram illustrating the spherical aberration, astigmatism and optical distortion of the optical image capturing system in order from left to right according to the fifth embodiment of the present invention.

FIG. 5C is a characteristic diagram of modulation transfer of visible light spectrum for the optical image capturing system according to the fifth embodiment of the present invention.

FIG. 6A is a schematic view of the optical image capturing system according to the sixth embodiment of the present application.

FIG. 6B is a curve diagram illustrating the spherical aberration, astigmatism and optical distortion of the optical image capturing system in order from left to right according to the sixth embodiment of the present invention.

FIG. 6C is a characteristic diagram of modulation transfer of visible light spectrum for the optical image capturing system according to the sixth embodiment of the present invention.

### DETAILED DESCRIPTION OF THE PREFERRED EMBODIMENTS

An optical image capturing system, in order from an object side to an image side, includes a first lens, a second lens, a third lens, a fourth lens, a fifth lens and a sixth lens with refractive power and an image plane. The optical image capturing system may further include an image sensing device which is disposed on an image plane.

The optical image capturing system may use three sets of wavelengths which are respectively 486.1 nm, 587.5 nm and 656.2 nm, wherein 587.5 nm is served as the primary reference wavelength and a reference wavelength for retrieving technical features. The optical image capturing system may also use five sets of wavelengths which are respectively 470 nm, 510 nm, 555 nm, 610 nm and 650 nm, wherein 555 nm is served as the primary reference wavelength and a reference wavelength for retrieving technical features.

The ratio of the focal length f of the optical image capturing system to a focal length fp of each of lenses with positive refractive power is PPR. The ratio of the focal length f of the optical image capturing system to a focal length fn of each of lenses with negative refractive power is NPR. The sum of the PPR of all lenses with positive refractive power is ΣPPR. The sum of the NPR of all lenses with negative refractive power is ΣNPR. The control of the total refractive power and the total length of the optical image capturing system is favorable when following conditions are satisfied: 0.5≤ΣPPR/|ΣNPR|≤15. Preferably, the following relationship is satisfied: 1≤ΣPPR/|ΣNPR|≤3.0.

The optical image capturing system may further include an image sensing device which is disposed on an image plane. A half of a diagonal of an effective detection field of the image sensing device (imaging height or the maximum image height of the optical image capturing system) is HOI. The distance on the optical axis from the object side of the first lens to the image plane is HOS. The following relationships are satisfied: HOS/HOI≤50 and 0.5≤HOS/f≤150. Preferably, the following relationships is satisfied: 1≤HOS/HOI≤40 and 1≤HOS/f≤140. Hereby, the miniaturization of the optical image capturing system can be maintained effectively, so as to be carried by lightweight portable electronic devices.

In addition, in the optical image capturing system of the present invention, according to different requirements, at least one aperture stop may be arranged for reducing stray light and improving the image quality.

In the optical image capturing system of the present invention, the aperture stop may be a front or middle aperture. The front aperture is the aperture stop between a photographed object and the first lens. The middle aperture is the aperture stop between the first lens and the image plane. If the aperture stop is the front aperture, a longer distance between the exit pupil and the image plane of the optical image capturing system can be generated, such that more optical elements can be disposed in the optical image capturing system and the efficiency of receiving images of the image sensing device can be raised. If the aperture stop is the middle aperture, the angle of view of the optical image capturing system can be expanded, such that the optical image capturing system has the advantage of the wide angle lens. The distance from the aperture stop to the image plane is InS. The following relationship is satisfied: 0.1≤InS/HOS≤1.1. Hereby, the miniaturization of the optical image capturing system can be maintained while the feature of the wild-angle lens can be achieved.

In the optical image capturing system of the present invention, the distance from the object side of the first lens to the image side of the sixth lens is InTL. A total central thickness of all lenses with refractive power on the optical axis is ETP. The following relationship is satisfied: 0.1≤ETP/InTL≤0.9. Hereby, the contrast ratio for the image formation in the optical image capturing system and yield rate for manufacturing the lens can be given consideration simultaneously, and a proper back focal length is provided to dispose other optical components in the optical image capturing system.

The curvature radius of the object side of the first lens is R1. The curvature radius of the image side of the first lens is R2. The following relationship is satisfied: 0.001≤|R1/R2|≤25. Hereby, the first lens may have proper strength of the positive refractive power, so as to avoid the longitudinal spherical aberration from increasing too fast. Preferably, the following relationship may be satisfied: 0.01≤|R1/R2|<12.

The curvature radius of the object side of the sixth lens is R11. The curvature radius of the image side of the sixth lens is R12. The following relationship is satisfied: −7<(R11−R12)/(R11+R12)<50. Hereby, the astigmatism generated by the optical image capturing system can be corrected beneficially.

The distance between the first lens and the second lens on the optical axis is IN12. The following relationship is satisfied: IN12/f≤60. Hereby, the chromatic aberration of the lenses can be improved, such that the performance can be increased.

The distance between the fifth lens and the sixth lens on the optical axis is IN56. The following relationship is satisfied: IN56/f≤3.0. Hereby, the chromatic aberration of the lenses can be improved, such that the performance can be increased.

Central thicknesses of the first lens and the second lens on the optical axis are respectively TP1 and TP2. The following relationship is satisfied: 0.1≤(TP1+IN12)/TP2≤10. Hereby, the sensitivity produced by the optical image capturing system can be controlled, and the performance can be increased.

Central thicknesses of the fifth lens and the sixth lens on the optical axis are respectively TP5 and TP6, and a distance between the aforementioned two lenses on the optical axis is IN56. The following relationship is satisfied: 0.1≤(TP6+IN56)/TP5≤15. Hereby, the sensitivity produced by the optical image capturing system can be controlled and the total height of the optical image capturing system can be reduced.

Central thicknesses of the second lens, the third lens and the fourth lens on the optical axis are respectively TP2, TP3 and TP4. The distance between the second lens and the third lens on the optical axis is IN23. A distance between the third lens and the forth lens on the optical axis is IN34. A distance between the fourth lens and the fifth lens on the optical axis is IN45. The distance between an object side of the first lens and an image side of the sixth lens is InTL. The following relationship is satisfied: 0.1≤TP4/(IN34+TP4+IN45)<1. Hereby, this configuration is helpful to slightly correct the aberration of the propagating process of the incident light layer by layer, and decrease the total height of the optical image capturing system.

In the optical image capturing system of the first embodiment, a distance perpendicular to the optical axis between a critical point C61 on an object side of the sixth lens and the optical axis is HVT61. The distance perpendicular to the optical axis between a critical point C62 on an image side of the sixth lens and the optical axis is HVT62. The horizontal distance parallel to the optical axis from an intersection point where the object side of the sixth lens crosses the optical axis to the critical point C61 may be expressed as SGC61. The horizontal distance parallel to the optical axis from an intersection point where the image side of the sixth lens crosses the optical axis to the critical point C62 may be expressed as SGC62. The following relationships may be satisfied: 0 mm≤HVT61≤3 mm, 0 mm<HVT62≤6 mm, 0≤HVT61/HVT62, 0 mm≤|SGC61|≤0.5 mm; 0 mm<|SGC62|≤2 mm and 0<|SGC62|/(|SGC62|+TP6)≤0.9. Hereby, the aberration of the off-axis field of view can be corrected effectively.

The following relationship is satisfied for the optical image capturing system of the present invention: 0.2≤HVT62/HOI≤0.9. Preferably, the following relationship may be satisfied: 0.3≤HVT62/HOI≤0.8. Hereby, the aberration at surrounding field of view for the optical image capturing system can be corrected beneficially.

The following relationship is satisfied for the optical image capturing system of the present invention: 0≤HVT62/HOS≤0.5. Preferably, the following relationship may be satisfied: 0.2≤HVT62/HOS≤0.45. Hereby, the aberration at surrounding field of view for the optical image capturing system can be corrected beneficially.

In the optical image capturing system of the present invention, the horizontal distance parallel to an optical axis from an inflection point on the object side of the sixth lens which is the first nearest to the optical axis to an intersection point where the object side of the sixth lens crosses the optical axis is denoted by SGI611. The horizontal distance parallel to an optical axis from an inflection point on the image side of the sixth lens which is the first nearest to the optical axis to an intersection point where the image side of the sixth lens crosses the optical axis is denoted by SGI621. The following relationships may be satisfied: 0<SGI611/(SGI611+TP6) 0.9 and 0<SGI621/(SGI621+TP6)≤0.9. Preferably, the following relationships may be satisfied: 0.1≤SGI611/(SGI611+TP6)≤0.6 and 0.1≤SGI621/(SGI621+TP6)≤0.6.

The horizontal distance parallel to the optical axis from the inflection point on the object side of the sixth lens which is the second nearest to the optical axis to an intersection point where the object side of the sixth lens crosses the optical axis is denoted by SGI612. The horizontal distance parallel to an optical axis from an inflection point on the image side of the sixth lens which is the second nearest to the optical axis to an intersection point where the image side of the sixth lens crosses the optical axis is denoted by SGI622. The following relationships may be satisfied: 0<SGI612/(SGI612+TP6)≤0.9 and 0<SGI622/(SGI622+TP6)≤0.9. Preferably, the following relationships may be satisfied: 0.1≤SGI612/(SGI612+TP6)≤0.6 and 0.1≤SGI622/(SGI622+TP6)≤0.6.

The distance perpendicular to the optical axis between the inflection point on the object side of the sixth lens which is the first nearest to the optical axis and the optical axis is denoted by HIF611. The distance perpendicular to the optical axis between an intersection point where the image side of the sixth lens crosses the optical axis and an inflection point on the image side of the sixth lens which is the first nearest to the optical axis is denoted by HIF621. The following relationships may be satisfied: 0.001 mm≤|HIF611|≤5 mm and 0.001 mm≤|HIF621|≤5 mm Preferably, the following relationships may be satisfied: 0.1 mm≤|HIF611|≤3.5 mm and 1.5 mm≤|HIF621|≤3.5 mm.

The distance perpendicular to the optical axis between the inflection point on the object side of the sixth lens which is the second nearest to the optical axis and the optical axis is denoted by HIF612. The distance perpendicular to the optical axis between an intersection point where the image side of the sixth lens crosses the optical axis and an inflection point on the image side of the sixth lens which is the second nearest to the optical axis is denoted by HIF622. The following relationships may be satisfied: 0.001 mm≤|HIF612|≤5 mm and 0.001 mm≤|HIF622|≤5 mm Preferably, the following relationships may be satisfied: 0.1 mm≤|HIF622|≤3.5 mm and 0.1 mm≤|HIF612|≤3.5 mm.

The distance perpendicular to the optical axis between the inflection point on the object side of the sixth lens which is the third nearest to the optical axis and the optical axis is denoted by HIF613. The distance perpendicular to the optical axis between an intersection point where the image side of the sixth lens crosses the optical axis and an inflection point on the image side of the sixth lens which is the third nearest to the optical axis is denoted by HIF623. The following relationships are satisfied: 0.001 mm≤|HIF613|≤5 mm and 0.001 mm≤|HIF623|≤5 mm Preferably, the following relationships may be satisfied: 0.1 mm≤|HIF623|≤3.5 mm and 0.1 mm≤|HIF613|≤3.5 mm.

The distance perpendicular to the optical axis between the inflection point on the object side of the sixth lens which is the fourth nearest to the optical axis and the optical axis is denoted by HIF614. The distance perpendicular to the optical axis between an intersection point where the image side of the sixth lens crosses the optical axis and an inflection point on the image side of the sixth lens which is the fourth nearest to the optical axis is denoted by HIF624. The following relationships are satisfied: 0.001 mm≤|HIF614|≤5 mm and 0.001 mm≤|HIF624|≤5 mm Preferably, the following relationships may be satisfied: 0.1 mm≤|HIF624|≤3.5 mm and 0.1 mm≤|HIF614|≤3.5 mm.

In one embodiment of the optical image capturing system of the present invention, the chromatic aberration of the optical image capturing system can be corrected by alternatively arranging the lenses with large coefficient of dispersion and small coefficient of dispersion.

The equation for the aforementioned aspheric surface is:

z=ch²[1+[1−(k+1)c²h²]^{0.5}]+A₄h⁴+A₆h⁶+A₈⁸+A₁₀h¹⁰+A₁₂h¹²+A₁₄h¹⁴+A₁₆h¹⁶+A₁₈h¹⁸+A₂₀h²⁰+ (1),

where z is a position value of the position along the optical axis and at the height h which refers to the surface apex; k is the cone coefficient, c is the reciprocal of curvature radius, and A₄, A₆, A₈, A₁₀, A₁₂, A₁₄, A₁₆, A₁₈, and A₂₀ are high order aspheric coefficients.

In the optical image capturing system provided by the present invention, the lenses may be made of plastic or glass. If a plastic material is adopted to produce the lenses, the cost and weight of manufacturing will be lowered effectively. If lenses are made of glass, the heat effect can be controlled and the designed space arranged for the refractive power of the optical image capturing system can be increased. Furthermore, the object side and the image side of the first lens through the sixth lens may be aspheric, so as to obtain more control variables. Comparing with the usage of traditional lens made by glass, the number of lenses used can be reduced, in addition to elimination of the aberration. Thus, the total height of the optical image capturing system can be reduced effectively.

In addition, in the optical image capturing system provided by the present invention, if the lens has a convex surface, the surface of the lens adjacent to the optical axis is principally convex. If the lens has a concave surface, the surface of the lens adjacent to the optical axis is principally concave.

The optical image capturing system of the present invention can be applied to the optical image capturing system with automatic focus based on the demand and has the characteristics of good aberration correction and good image quality. Thereby, the optical image capturing system expands the application aspect.

The optical image capturing system of the present invention can further include a driving module based on the demand. The driving module may be coupled with the lens and enable the movement of the lens. The foregoing driving module may be the voice coil motor (VCM) which is applied to move the lens to focus, or may be the optical image stabilization (OIS) which is applied to reduce the frequency which lead to the out focus due to the vibration of the camera lens in the shooting process.

At least one of the first lens, the second lens, the third lens, the fourth lens, the fifth lens and the sixth lens of the optical image capturing system of the present invention may further be designed as a light filtering element with a wavelength of less than 500 nm based on the demand. The light filtering element may be made by coating film on at least one surface of that lens with certain filtering function, or forming that lens with material that can filter light with short wavelength.

The image plane of the optical image capturing system of the present invention may be a plane or a curved surface based on the design requirements. When the image plane is a curved surface (e.g. a spherical surface with curvature radius), the decrease of the required incident angle to focus rays on the image plane is helpful. In addition to the aid of the miniaturization of the length of the optical image capturing system (TTL), this configuration is helpful to elevate the relative illumination at the same time.

According to the above embodiments, the specific embodiments with figures are presented in detail as below.

### The First Embodiment (Embodiment 1)

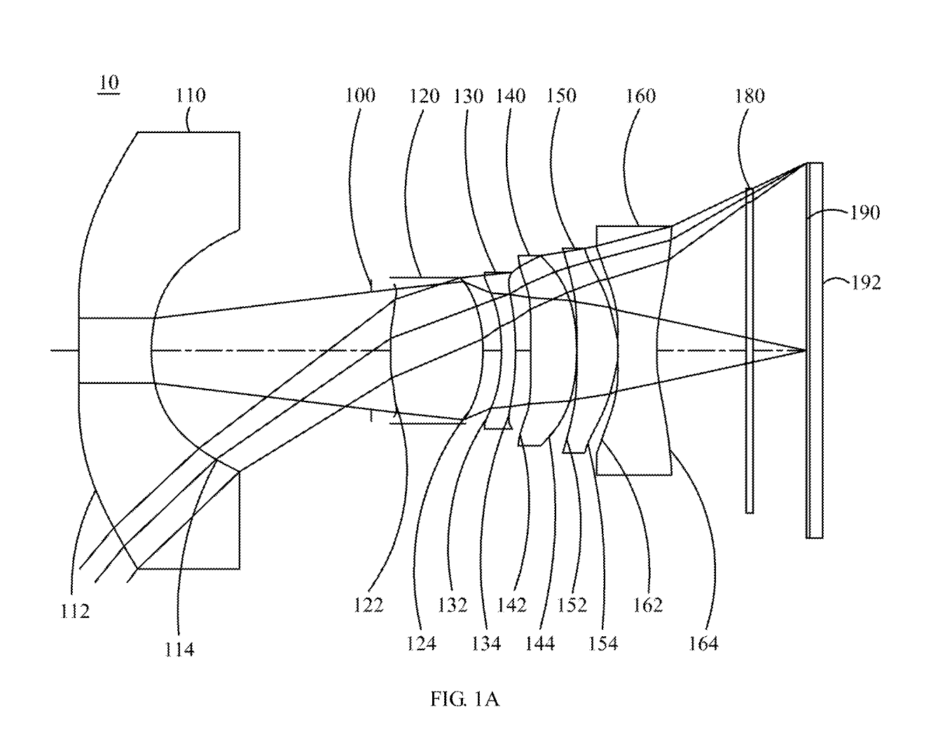

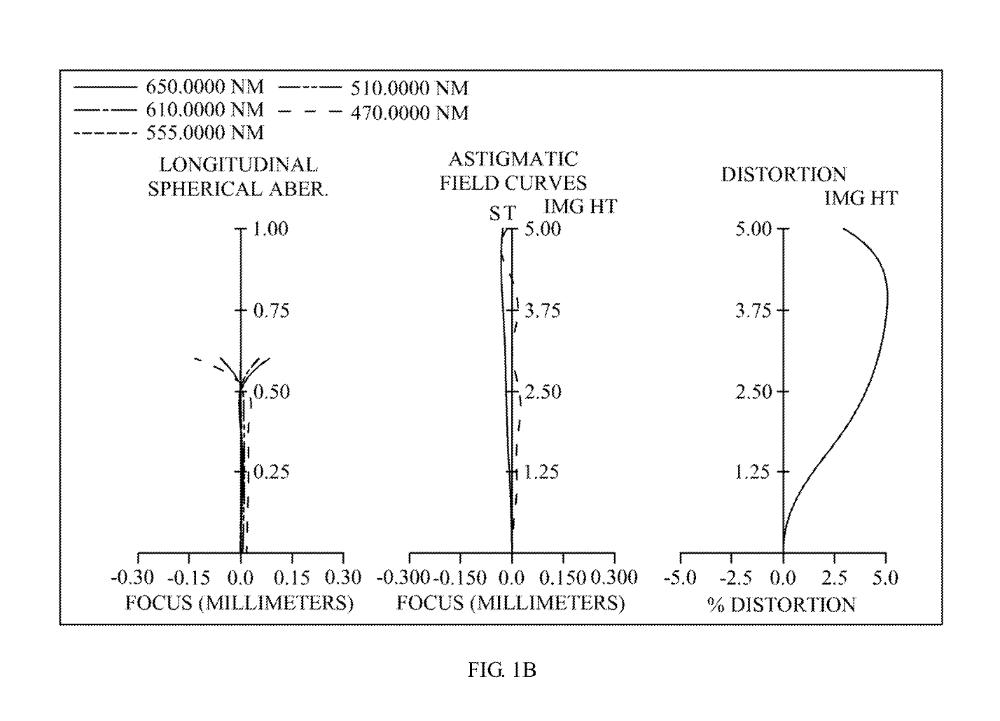

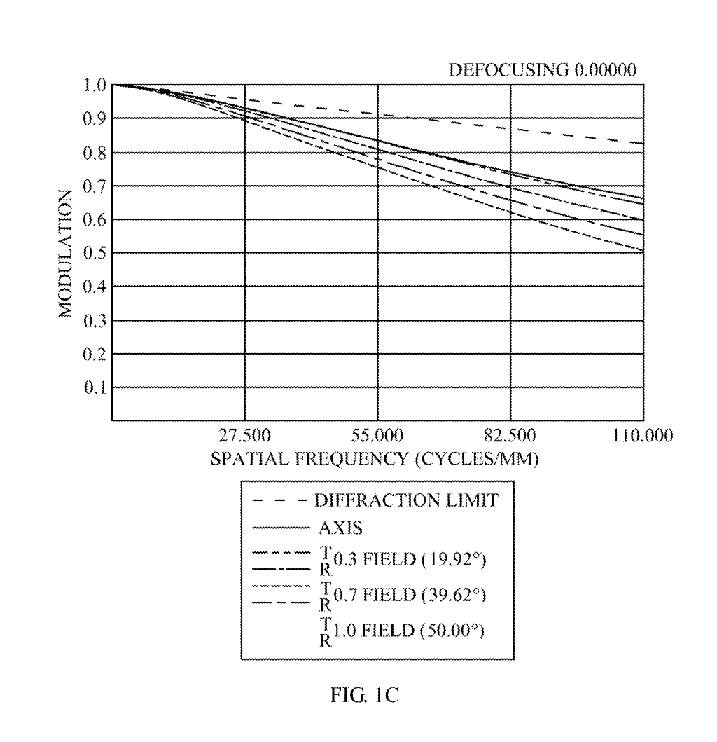

Please refer to FIG. 1A, FIG. 1B and FIG. 1C. FIG. 1A is a schematic view of the optical image capturing system according to the first embodiment of the present application, FIG. 1B is longitudinal spherical aberration curves, astigmatic field curves, and an optical distortion curve of the optical image capturing system in the order from left to right according to the first embodiment of the present invention, and FIG. 1C is a characteristic diagram of modulation transfer of visible light of the first embodiment of the present invention. As shown in FIG. 1A, in order from an object side to an image side, the optical image capturing system 10 includes a first lens 110, an aperture stop 100, a second lens 120, a third lens 130, a fourth lens 140, a fifth lens 150, a sixth lens 160, an IR-bandstop filter 180, an image plane 190, and an image sensing device 192.

The first lens 110 has negative refractive power and is made of plastic. The first lens 110 has a concave object side 112 and a concave image side 114. Both of the object side 112 and the image side 114 of the first lens 110 are aspheric. The object side 112 of the first lens 110 has two inflection points. The thickness of the first lens 110 on the optical axis may be expressed as TP1. The thickness of the first lens 110 at a height of ½ entrance pupil diameter (HEP) may be expressed as ETP1.

The horizontal distance parallel to an optical axis from an inflection point on the object side 112 of the first lens 110 which is the first nearest to the optical axis to an intersection point where the object side 112 of the first lens 110 crosses the optical axis is denoted by SGI111. The horizontal distance parallel to an optical axis from an inflection point on the image side 114 of the first lens 110 which is the first nearest to the optical axis to an intersection point where the image side 114 of the first lens 110 crosses the optical axis is denoted by SGI121. The following relationships may be satisfied: SGI111=−0.0031 mm and |SGI111|/(|SGI111|+TP1)=0.0016.

The horizontal distance parallel to an optical axis from an inflection point on the object side 112 of the first lens 110 which is the second nearest to the optical axis to an intersection point where the object side 112 of the first lens 110 crosses the optical axis is denoted by SGI112. The horizontal distance parallel to an optical axis from an inflection point on the image side 114 of the first lens 110 which is the second nearest to the optical axis to an intersection point where the image side 114 of the first lens 110 crosses the optical axis is denoted by SGI122. The following relationships may be satisfied: SGI112=1.3178 mm and |SGI112|/(|SGI112|+TP1)=0.4052.

The distance perpendicular to the optical axis between the inflection point on the object side 112 of the first lens 110 which is the first nearest to the optical axis and the optical axis is denoted by HIF111. The distance perpendicular to the optical axis between an intersection point where the image side 114 of the first lens 110 crosses the optical axis and an inflection point on the image side 114 of the first lens 110 which is the first nearest to the optical axis is denoted by HIF121. The following relationships may be satisfied: HIF111=0.5557 mm; HIF111/HOI=0.1111.

The distance perpendicular to the optical axis between the inflection point on the object side 112 of the first lens 110 which is the second nearest to the optical axis and the optical axis is denoted by HIF112. The distance perpendicular to the optical axis between an intersection point where the image side 114 of the first lens 110 crosses the optical axis and an inflection point on the image side 114 of the first lens 110 which is the second nearest to the optical axis is denoted by HIF122. The following relationships may be satisfied: HIF112=5.3732 mm and HIF112/HOI=1.0746.

The second lens 120 has positive refractive power and is made of plastic. The second lens 120 has a convex object side 122 and a convex image side 124. Both of the object side 122 and the image side 124 of the second lens 120 are aspheric. The object side 122 of the second lens 120 has one inflection point. The thickness of the second lens 120 on the optical axis is TP2. The thickness of the second lens 120 at the height of ½ entrance pupil diameter (HEP) may be expressed as ETP2.

The horizontal distance parallel to an optical axis from an inflection point on the object side 122 of the second lens 120 which is the first nearest to the optical axis to an intersection point where the object side 122 of the second lens 120 crosses the optical axis is denoted by SGI211. the horizontal distance parallel to an optical axis from an inflection point on the image side 122 of the second lens 120 which is the first nearest to the optical axis to an intersection point where the image side of the second lens crosses the optical axis is denoted by SGI221. The following relationships may be satisfied: SGI211=0.1069 mm, |SGI211|/(|SGI211|+TP2)=0.0412, SGI221=0 mm and |SGI221|/(|SGI221|+TP2)=0.

The distance perpendicular to the optical axis from the inflection point on the object side 122 of the second lens 120 which is the first nearest to the optical axis to an intersection point where the object side 122 of the second lens 120 crosses the optical axis is denoted by HIF211. The distance perpendicular to the optical axis from the inflection point on the image side 124 of the second lens 120 which is the first nearest to the optical axis to an intersection point where the image side 124 of the second lens 120 crosses the optical axis is denoted by HIF221. The following relationships may be satisfied: HIF211=1.1264 mm, HIF211/HOI=0.2253, HIF221=0 mm and HIF221/HOI=0.

The third lens 130 has negative refractive power and is made of plastic. The third lens 130 has a concave object side 132 and a convex image side 134, and both of the object side 132 and the image side 134 of the third lens 130 are aspheric. Both of the object side 132 and the image side 134 of the third lens 130 have an inflection point. The thickness of the third lens 130 on the optical axis is TP3. The thickness of the third lens 130 at the height of ½ entrance pupil diameter (HEP) may be expressed as ETP3.

The horizontal distance parallel to an optical axis from an inflection point on the object side 132 of the third lens 130 which is the first nearest to the optical axis to an intersection point where the object side 132 of the third lens 130 crosses the optical axis is denoted by SGI311. The horizontal distance parallel to an optical axis from an inflection point on the image side 134 of the third lens 130 which is the first nearest to the optical axis to an intersection point where the image side 134 of the third lens 130 crosses the optical axis is denoted by SGI321. The following relationships may be satisfied: SGI311=−0.3041 mm, |SGI311|/(|SGI311|+TP3)=0.4445, SGI321=−0.1172 mm and |SGI321|/(|SGI321|+TP3)=0.2357.

The distance perpendicular to the optical axis between the inflection point on the object side 132 of the third lens 130 which is the first nearest to the optical axis and the optical axis is denoted by HIF311. The distance perpendicular to the optical axis from the inflection point on the image side 134 of the third lens 130 which is the first nearest to the optical axis to an intersection point where the image side 134 of the third lens 130 crosses the optical axis is denoted by HIF321. The following relationships may be satisfied: HIF311=1.5907 mm, HIF311/HOI=0.3181, HIF321=1.3380 mm and HIF321/HOI=0.2676.

The fourth lens 140 has positive refractive power and is made of plastic. The fourth lens 140 has a convex object side 142 and a concave image side 144. Both of the object side 142 and the image side 144 of the fourth lens 140 are aspheric. The object side 142 of the fourth lens 140 has two inflection points. The image side 144 of the fourth lens 140 has an inflection point. The thickness of the fourth lens 140 on the optical axis is TP4. The thickness of the fourth lens 140 at the height of ½ entrance pupil diameter (HEP) may be expressed as ETP4.

The horizontal distance parallel to an optical axis from an inflection point on the object side 142 of the fourth lens 140 which is the first nearest to the optical axis to an intersection point where the object side 142 of the fourth lens 140 crosses the optical axis is denoted by SGI411. The horizontal distance parallel to an optical axis from an inflection point on the image side 144 of the fourth lens 140 which is the first nearest to the optical axis to an intersection point where the image side 144 of the fourth lens 140 crosses the optical axis is denoted by SGI421. The following relationships may be satisfied: SGI411=0.0070 mm, |SGI411|/(|SGI411|+TP4)=0.0056, SGI421=0.0006 mm and |SGI421|/(|SGI421|+TP4)=0.0005.

The horizontal distance parallel to an optical axis from an inflection point on the object side 142 of the fourth lens 140 which is the second nearest to the optical axis to an intersection point where the object side 142 of the fourth lens 140 crosses the optical axis is denoted by SGI412. The horizontal distance parallel to an optical axis from an inflection point on the image side 144 of the fourth lens 140 which is the second nearest to the optical axis to an intersection point where the image side 144 of the fourth lens 140 crosses the optical axis is denoted by SGI422. The following relationships may be satisfied: SGI412=−0.2078 mm and |SGI412|/(|SGI412|+TP4)=0.1439.

The distance perpendicular to the optical axis between the inflection point on the object side 142 of the fourth lens 140 which is the first nearest to the optical axis and the optical axis is denoted by HIF411. The distance perpendicular to the optical axis from the inflection point on the image side 144 of the fourth lens 140 which is the first nearest to the optical axis to an intersection point where the image side 144 of the fourth lens 140 crosses the optical axis is denoted by HIF421. The following relationships may be satisfied: HIF411=0.4706 mm, HIF411/HOI=0.0941, HIF421=0.1721 mm and HIF421/HOI=0.0344.

The distance perpendicular to the optical axis between the inflection point on the object side 142 of the fourth lens 140 which is the second nearest to the optical axis and the optical axis is denoted by HIF412. The distance perpendicular to the optical axis from the inflection point on the image side 144 of the fourth lens 140 which is the second nearest to the optical axis to an intersection point where the image side 144 of the fourth lens 140 crosses the optical axis is denoted by HIF422. The following relationships may be satisfied: HIF412=2.0421 mm and HIF412/HOI=0.4084.

The fifth lens 150 has positive refractive power and is made of plastic. The fifth lens 150 has a convex object side 152 and a convex image side 154. Both of the object side 152 and the image side 154 of the fifth lens 150 are aspheric. The object side 152 of the fifth lens 150 has two inflection points and the image side 154 of the fifth lens 150 has an inflection point. The thickness of the fifth lens 150 on the optical axis is TP5. The thickness of the fifth lens 150 at the height of ½ entrance pupil diameter (HEP) may be expressed as ETP5.

The horizontal distance parallel to an optical axis from an inflection point on the object side 152 of the fifth lens 150 which is the first nearest to the optical axis to an intersection point where the object side 152 of the fifth lens 150 crosses the optical axis is denoted by SGI511. The horizontal distance parallel to an optical axis from an inflection point on the image side 154 of the fifth lens 150 which is the first nearest to the optical axis to an intersection point where the image side 154 of the fifth lens 150 crosses the optical axis is denoted by SGI521. The following relationships may be satisfied: SGI511=0.00364 mm, |SGI511|/(|SGI511|+TP5)=0.00338, SGI521=−0.63365 mm and |SGI521|/(|SGI521|+TP5)=0.37154.

The horizontal distance parallel to an optical axis from an inflection point on the object side 152 of the fifth lens 150 which is the second nearest to the optical axis to an intersection point where the object side 152 of the fifth lens 150 crosses the optical axis is denoted by SGI512. The horizontal distance parallel to an optical axis from an inflection point on the image side 154 of the fifth lens 150 which is the second nearest to the optical axis to an intersection point where the image side 154 of the fifth lens 150 crosses the optical axis is denoted by SGI522. The following relationships are satisfied: SGI512=−0.32032 mm and |SGI512|/(|SGI512|+TP5)=0.23009.

The horizontal distance parallel to an optical axis from an inflection point on the object side 152 of the fifth lens 150 which is the third nearest to the optical axis to an axial point on the object side 152 of the fifth lens 150 is denoted by SGI513. The horizontal distance parallel to an optical axis from an inflection point on the image side 154 of the fifth lens 150 which is the third nearest to the optical axis to an axial point on the image side 154 of the fifth lens 150 is denoted by SGI523. The following relationships may be satisfied: SGI513=0 mm, |SGI513|/(|SGI513|+TP5)=0, SGI523=0 mm and |SGI523|/(|SGI523|+TP5)=0.

The horizontal distance parallel to an optical axis from an inflection point on the object side 152 of the fifth lens 150 which is the fourth nearest to the optical axis to an axial point on the object side 152 of the fifth lens 150 is denoted by SGI514. The horizontal distance parallel to an optical axis from an inflection point on the image side 154 of the fifth lens 150 which is the fourth nearest to the optical axis to an axial point on the image side 154 of the fifth lens 150 is denoted by SGI524. The following relationships may be satisfied: SGI514=0 mm, |SGI514|/(|SGI514|+TP5)=0, SGI524=0 mm and |SGI524|/(|SGI524|+TP5)=0.

The distance perpendicular to the optical axis between the inflection point on the object side 152 of the fifth lens 150 which is the first nearest to the optical axis and the optical axis is denoted by HIF511. The distance perpendicular to the optical axis between the inflection point on the image side 154 of the fifth lens 150 which is the first nearest to the optical axis and the optical axis is denoted by HIF521. The following relationships may be satisfied: HIF511=0.28212 mm, HIF511/HOI=0.05642, HIF521=2.13850 mm and HIF521/HOI=0.42770.

The distance perpendicular to the optical axis between the inflection point on the object side 152 of the fifth lens 150 which is the second nearest to the optical axis and the optical axis is denoted by HIF512. The distance perpendicular to the optical axis between the inflection point on the image side 154 of the fifth lens 150 which is the second nearest to the optical axis and the optical axis is denoted by HIF522. The following relationships may be satisfied: HIF512=2.51384 mm and HIF512/HOI=0.50277.

The distance perpendicular to the optical axis between the inflection point on the object side 152 of the fifth lens 150 which is the third nearest to the optical axis and the optical axis is denoted by HIF513. The distance perpendicular to the optical axis between the inflection point on the image side 154 of the fifth lens 150 which is the third nearest to the optical axis and the optical axis is denoted by HIF523. The following relationships are satisfied: HIF513=0 mm, HIF513/HOI=0, HIF523=0 mm and HIF523/HOI=0.

The distance perpendicular to the optical axis between the inflection point on the object side 152 of the fifth lens 150 which is the fourth nearest to the optical axis and the optical axis is denoted by HIF514. The distance perpendicular to the optical axis between the inflection point on the image side 154 of the fifth lens 150 which is the fourth nearest to the optical axis and the optical axis is denoted by HIF524. The following relationships may be satisfied: HIF514=0 mm, HIF514/HOI=0, HIF524=0 mm and HIF524/HOI=0.

The sixth lens 160 has negative refractive power and is made of plastic. The sixth lens 160 has a concave object side 162 and a concave image side 164. The object side 162 of the sixth lens 160 has two inflection points and the image side 164 of the sixth lens 160 has one inflection point. Hereby, the angle of incident of each field of view on the sixth lens 160 can be effectively adjusted and the spherical aberration can thus be improved. The thickness of the sixth lens 160 on the optical axis is TP6. The thickness of the sixth lens 160 at the height of ½ entrance pupil diameter (HEP) may be expressed as ETP6.

The horizontal distance parallel to an optical axis from an inflection point on the object side 162 of the sixth lens 160 which is the first nearest to the optical axis to an intersection point where the object side 162 of the sixth lens 160 crosses the optical axis is denoted by SGI611. The horizontal distance parallel to an optical axis from an inflection point on the image side 164 of the sixth lens 160 which is the first nearest to the optical axis to an intersection point where the image side 164 of the sixth lens 160 crosses the optical axis is denoted by SGI621. The following relationships may be satisfied: SGI611=−0.38558 mm, |SGI611|/(|SGI611|+TP6)=0.27212, SGI621=0.12386 mm and |SGI621|/(|SGI621|+TP6)=0.10722.

The horizontal distance parallel to an optical axis from an inflection point on the object side 162 of the sixth lens 160 which is the second nearest to the optical axis to an intersection point where the object side 162 of the sixth lens 160 crosses the optical axis is denoted by SGI612. The horizontal distance parallel to an optical axis from an inflection point on the image side 164 of the sixth lens 160 which is the second nearest to the optical axis to an intersection point where the image side 164 of the sixth lens 160 crosses the optical axis is denoted by SGI622. The following relationships may be satisfied: SGI612=−0.47400 mm, |SGI612|/(|SGI612|+TP6)=0.31488, SGI622=0 mm and |SGI622|/(|SGI622|+TP6)=0.

The distance perpendicular to the optical axis between the inflection point on the object side 162 of the sixth lens 160 which is the first nearest to the optical axis and the optical axis is denoted by HIF611. The distance perpendicular to the optical axis between the inflection point on the image side 164 of the sixth lens 160 which is the first nearest to the optical axis and the optical axis is denoted by HIF621. The following relationships may be satisfied: HIF611=2.24283 mm, HIF611/HOI=0.44857, HIF621=1.07376 mm and HIF621/HOI=0.21475.

The distance perpendicular to the optical axis between the inflection point on the object side 162 of the sixth lens 160 which is the second nearest to the optical axis and the optical axis is denoted by HIF612. The distance perpendicular to the optical axis between the inflection point on the image side 164 of the sixth lens 160 which is the second nearest to the optical axis and the optical axis is denoted by HIF622. The following relationships may be satisfied: HIF612=2.48895 mm and HIF612/HOI=0.49779.

The distance perpendicular to the optical axis between the inflection point on the object side 162 of the sixth lens 160 which is the third nearest to the optical axis and the optical axis is denoted by HIF613. The distance perpendicular to the optical axis between the inflection point on the image side 164 of the sixth lens 160 which is the third nearest to the optical axis and the optical axis is denoted by HIF623. The following relationships may be satisfied: HIF613=0 mm, HIF613/HOI=0, HIF623=0 mm and HIF623/HOI=0.

The distance perpendicular to the optical axis between the inflection point on the object side 162 of the sixth lens 160 which is the fourth nearest to the optical axis and the optical axis is denoted by HIF614. The distance perpendicular to the optical axis between the inflection point on the image side 164 of the sixth lens 160 which is the fourth nearest to the optical axis and the optical axis is denoted by HIF624. The following relationships may be satisfied: HIF614=0 mm, HIF614/HOI=0, HIF624=0 mm and HIF624/HOI=0.

In the first embodiment, the distance parallel to the optical axis between the coordinate point of the object side 112 of the first lens 110 at a height of ½ HEP and the image plane 190 may be expressed as ETL. The distance parallel to the optical axis between the coordinate point of the object side 112 of the first lens 110 at a height of ½ HEP and the coordinate point of the image side 164 of the sixth lens 160 at a height of ½ HEP may be expressed as EIN. The following conditions may be satisfied: ETL=19.304 mm, EIN=15.733 mm and EIN/ETL=0.815.

The first embodiment meets the following conditions: ETP1=2.371 mm; ETP2=2.134 mm; ETP3=0.497 mm; ETP4=1.111 mm; ETP5=1.783 mm; ETP6=1.404 mm; the sum of ETP1 to ETP6 described above SETP=9.300 mm; TP1=2.064 mm; TP2=2.500 mm; TP3=0.380 mm; TP4=1.186 mm; TP5=2.184 mm, TP6=1.105 mm, the sum of TP1 to TP6 described above STP=9.419 mm; SETP/STP=0.987, and SETP/EIN=0.5911.

The first embodiment particularly controls the ratio relationship (ETP/TP) between the thickness (ETP) of each lens at a height of ½ entrance pupil diameter (HEP) and the thickness (TP) of the lens to which the surface belongs on the optical axis in order to achieve a balance between manufacturability and capability of aberration correction. The following relationships may be satisfied: ETP1/TP1=1.149, ETP2/TP2=0.854, ETP3/TP3=1.308, ETP4/TP4=0.936, ETP5/TP5=0.817 and ETP6/TP6=1.271.

The first embodiment controls the horizontal distance between each two adjacent lenses at a height of ½ entrance pupil diameter (HEP) to achieve a balance between the degree of miniaturization for the length of the optical image capturing system HOS, the manufacturability and the capability of aberration correction. The ratio relationship (ED/IN) of the horizontal distance (ED) between the two adjacent lens at the height of ½ entrance pupil diameter (HEP) to the horizontal distance (IN) on the optical axis between the two adjacent lens is particularly controlled. The following relationships are satisfied: the horizontal distance parallel to the optical axis between the first lens 110 and the second lens 120 at a height of ½ entrance pupil diameter (HEP) ED12=5.285 mm. The horizontal distance parallel to the optical axis between the second lens 120 and the third lens 130 at a height of ½ entrance pupil diameter (HEP) ED23=0.283 mm. The horizontal distance parallel to the optical axis between the third lens 130 and the fourth lens 140 at a height of ½ entrance pupil diameter (HEP) ED34=0.330 mm. The horizontal distance parallel to the optical axis between the fourth lens 140 and the fifth lens 150 at a height of ½ entrance pupil diameter (HEP) ED45=0.348 mm. The horizontal distance parallel to the optical axis between the fifth lens 150 and the sixth lens 160 at a height of ½ entrance pupil diameter (HEP) ED56=0.187 mm. The sum of ED12 to ED56 described above is expressed as SED, and SED=6.433 mm.

The horizontal distance on the optical axis between the first lens 110 and the second lens 120 IN12=5.470 mm and ED12/IN12=0.966. The horizontal distance on the optical axis between the second lens 120 and the third lens 130 IN23=0.178 mm and ED23/IN23=1.590. The horizontal distance on the optical axis between the third lens 130 and the fourth lens 140 IN34=0.259 mm and ED34/IN34=1.273. The horizontal distance on the optical axis between the fourth lens 140 and the fifth lens 150 IN45=0.209 mm and ED45/IN45=1.664. The horizontal distance on the optical axis between the fifth lens 150 and the sixth lens 160 IN56=0.034 mm and ED56/IN56=5.557. The sum of IN12 to IN56 described above is expressed as SIN and SIN=6.150 mm SED/SIN=1.046.

The first embodiment meets the following conditions: ED12/ED23=18.685, ED23/ED34=0.857, ED34/ED45=0.947, ED45/ED56=1.859, IN12/IN23=30.746, IN23/IN34=0.686, IN34/IN45=1.239, and IN45/IN56=6.207.

The horizontal distance parallel to the optical axis between a coordinate point on the image side 164 of the sixth lens 160 at the height of ½ HEP and the image plane 190 may be expressed as EBL=3.570 mm. The horizontal distance parallel to the optical axis between an intersection point where the image side 164 of the sixth lens 160 crosses the optical axis and the image plane 190 may be expressed as BL=4.032 mm. The embodiment of the present invention may meet the following relationship: EBL/BL=0.8854. In the first embodiment, the distance parallel to the optical axis between the coordinate point on the image side 164 of the sixth lens 160 at the height of ½ HEP and the IR-bandstop filter may be expressed as EIR=1.950 mm. The distance parallel to the optical axis between the intersection point where the image side 164 of the sixth lens 160 crosses the optical axis and the IR-bandstop filter may be expressed as PIR=2.121 mm. The following relationship is satisfied: EIR/PIR=0.920.

The IR-bandstop filter 180 is made of glass and is disposed between the sixth lens 160 and the image plane 190 without affecting the focal length of the optical image capturing system 10.

In the optical image capturing system 10 of the first embodiment, the focal length f of the optical image capturing system 10 may be expressed as f. The entrance pupil diameter of the optical image capturing system 10 may be expressed as HEP. The half maximum angle of view of the optical image capturing system 10 may be expressed as HAF. The detailed parameters are shown as below: f=4.075 mm, f/HEP=1.4, HAF=50.001 deg and tan (HAF)=1.1918.

In the optical image capturing system 10 of the first embodiment, the focal length of the first lens 110 may be expressed as f. The focal length of the sixth lens 160 may be expressed as f6. The following conditions may be satisfied: f1=−7.828 mm, |f/f1|=0.52060, f6=−4.886 mm and |f1|>|f6|.

In the optical image capturing system 10 of the first embodiment, focal lengths of the second lens 120 through the fifth 150 lens may be expressed respectively as f2, f3, f4 and f5. The following conditions may be satisfied: |f2|+|f3|+|f4|+|f5|=95.50815 mm, |f1|+|f6|=12.71352 mm and |f2|+|f3|+|f4|+|f5|>f1|+|f6|.

The ratio of the focal length f of the optical image capturing system 10 to the focal length fp of each lens with positive refractive power may be expressed as PPR. The ratio of the focal length f of the optical image capturing system 10 to the focal length fn of each lens with negative refractive power may be expressed as NPR. The sum of the PPR of all lenses with positive refractive power may be expressed as ΣPPR=f/f2+f/f4+f/f5=1.63290. The sum of the NPR of all lenses with negative refractive power may be expressed as ΣNPR=|f/f1|+|f/f3|+|f/f6|=1.51305, and ΣPPR/|ΣNPR|=1.07921. The following conditions may be also satisfied: |f/f2|=0.69101, |f/f3|=0.15834, |f/f4|=0.06883, |f/f5|=0.87305, |f/f6|=0.83412.

In the optical image capturing system 10 of the first embodiment, the distance from the object side 112 of the first lens 110 to the image side 164 of the sixth lens 160 may be expressed as InTL. The distance from the object side 112 of the first lens 110 to the image plane 190 may be expressed as HOS. The distance from the aperture 100 to the image plane 190 may be expressed as InS. The half diagonal length of an effective detection field of the image sensing device 192 may be expressed as HOI. The distance from the image side 164 of the sixth lens 160 to the image plane 190 may be expressed as BFL. The following conditions may be satisfied: InTL+BFL=HOS, HOS=19.54120 mm, HOI=5.0 mm, HOS/HOI=3.90824, HOS/f=4.7952, InS=11.685 mm and InS/HOS=0.59794.

In the optical image capturing system 10 of the first embodiment, the sum of thicknesses of all lenses with refractive power on the optical axis may be expressed as ETP. The following conditions may be satisfied: ΣTP=8.13899 mm and ΣTP/InTL=0.52477. Therefore, this configuration can keep the contrast ratio of the optical image capturing system 10 and the yield rate about manufacturing lens, and provide the proper back focal length to accommodate others.

In the optical image capturing system 10 of the first embodiment, the curvature radius of the object side 112 of the first lens 110 may be expressed as R1. The curvature radius of the image side 114 of the first lens 110 may be expressed as R2. The following condition is satisfied: |R1/R2|=8.99987. Hereby, the first lens 110 has a suitable magnitude of the positive refractive power, so as to prevent the spherical aberration from increasing too fast.

In the optical image capturing system 10 of the first embodiment, the curvature radius of the object side 162 of the sixth lens 160 may be expressed as R11. The curvature radius of the image side 164 of the sixth lens 160 may be expressed as R12. The following condition is satisfied: (R11−R12)/(R11+R12)=1.27780. Therefore, this configuration is beneficial for correcting the astigmatism generated by the optical image capturing system.

In the optical image capturing system 10 of the first embodiment, the sum of the focal lengths for all lenses having positive refractive power may be expressed as ΣPP, which satisfies the following conditions: ΣPP=f2+f4+f5=69.770 mm and f5/(f2+f4+f5)=0.067. Hereby, this configuration is helpful to distribute the positive refractive power of one lens to other lenses with positive refractive power in an appropriate way, so as to suppress the generation of noticeable aberrations in the propagating process of the incident light in the optical image capturing system.

In the optical image capturing system 10 of the first embodiment, the sum of the focal lengths for all lenses with negative refractive power may be expressed as ΣNP, which satisfies the following conditions: ΣNP=f1+f3+f6=−38.451 mm and f6/(f1+f3+f6)=0.127. Hereby, this configuration is helpful to distribute the negative refractive power of sixth lens 160 to other lenses with negative refractive power in an appropriate way, so as to suppress the generation of noticeable aberrations in the propagating process of the incident light in the optical image capturing system.

In the optical image capturing system 10 of the first embodiment, the distance on the optical axis between the first lens 110 and the second lens 120 may be expressed as IN12. The following conditions may be satisfied: IN12=6.418 mm and IN12/f=1.57491. Hereby, this configuration is helpful to improve the chromatic aberration of the lens in order to elevate the performance of the optical image capturing system of the first embodiment.

In the optical image capturing system 10 of the first embodiment, the distance on the optical axis between the fifth lens 150 and the sixth lens 160 may be expressed as IN56. The following conditions may be satisfied: IN56=0.025 mm and IN56/f=0.00613. Hereby, the configuration is helpful to improve the chromatic aberration of the lens in order to elevate the performance of the optical image capturing system of the first embodiment.

In the optical image capturing system 10 of the first embodiment, thicknesses of the first lens 110 and the second lens 120 on the optical axis may be expressed respectively as TP1 and TP2. The following conditions may be satisfied: TP1=1.934 mm, TP2=2.486 mm, and (TP1+IN12)/TP2=3.36005. Therefore, this configuration is helpful to control the sensitivity generated by the optical image capturing system and elevate the performance of the optical image capturing system of the first embodiment.

In the optical image capturing system 10 of the first embodiment, thicknesses of the fifth lens 150 and the sixth lens 160 on the optical axis may be respectively expressed as TP5 and TP6. The distance on the optical axis between the fifth lens 150 and the sixth lens 160 may be expressed as IN56. The following conditions may be satisfied: TP5=1.072 mm, TP6=1.031 mm, and (TP6+IN56)/TP5=0.98555. Therefore, this configuration is helpful to control the sensitivity generated by the optical image capturing system and reduce the total height of the optical image capturing system.

In the optical image capturing system 10 of the first embodiment, a distance between the third lens 130 and the fourth lens 140 on the optical axis is IN34. A distance between the fourth 140 lens and the fifth lens 150 on the optical axis is IN45. The following relationships are satisfied: IN34=0.401 mm, IN45=0.025 mm, and TP4/(IN34+TP4+IN45)=0.74376. Hereby, the aberration generated by the process of moving the incident light can be adjusted slightly layer upon layer, and the total height of the optical image capturing system can be reduced.

In the optical image capturing system 10 of the first embodiment, the horizontal distance parallel to the optical axis from an intersection point where the object side 152 of the fifth lens 150 crosses the optical axis to a maximum effective half diameter position on the object side 152 of the fifth lens 150 may be expressed as InRS51. The horizontal distance parallel to the optical axis from an intersection point where the image side 154 of the fifth lens 150 crosses the optical axis to a maximum effective half diameter position on the image side 154 of the fifth lens 150 may be expressed as InRS52. The thickness of the fifth lens 150 on the optical axis may be expressed as TP5. The following conditions are satisfied: InRS51=−0.34789 mm, InRS52=−0.88185 mm, |InRS51|/TP5=0.32458 and |InRS52|/TP5=0.82276. Hereby, this configuration is favorable to the manufacturing and forming of lens and keeps the miniaturization of the optical image capturing system effectively.

In the optical image capturing system 10 of the first embodiment, the perpendicular distance between a critical point C51 on the object side 152 of the fifth lens 150 and the optical axis may be expressed as HVT51. The perpendicular distance between a critical point C52 on the image side 154 of the fifth lens 150 and the optical axis may be expressed as HVT52. The following conditions are satisfied: HVT51=0.515349 mm and HVT52=0 mm.

In the optical image capturing system 10 of the first embodiment, the horizontal distance parallel to the optical axis from an intersection point where the object side 162 of the sixth lens 160 crosses the optical axis to a maximum effective half diameter position on the object side 162 of the sixth lens 160 may be expressed as InRS61. The horizontal distance parallel to the optical axis from an intersection point where the image side 164 of the sixth lens 160 crosses the optical axis to a maximum effective half diameter position on the image side 164 of the sixth lens 160 may be expressed as InRS62. The thickness of the sixth lens 160 is TP6. The following conditions are satisfied: InRS61=−0.58390 mm, InRS62=0.41976 mm, |InRS61|/TP6=0.56616 and |InRS62|/TP6=0.40700. Hereby, this configuration is favorable to the manufacturing and forming of lens and keeping the miniaturization of the optical image capturing system effectively.

In the optical image capturing system 10 of the first embodiment, the perpendicular distance between a critical point C61 on the object side 162 of the sixth lens 160 and the optical axis may be expressed as HVT61. The perpendicular distance between a critical point C62 on the image side 164 of the sixth lens 160 and the optical axis may be expressed as HVT62. The following conditions are satisfied: HVT61=0 mm and HVT62=0 mm.

In the optical image capturing system 10 of the first embodiment, the following condition is satisfied: HVT51/HOI=0.1031. Therefore, this configuration is helpful to correct the aberration of surrounding field of view of the optical image capturing system.

In the optical image capturing system 10 of the first embodiment, the following condition is satisfied: HVT51/HOS=0.02634. Therefore, this configuration is helpful to correct the aberration of surrounding field of view of the optical image capturing system.

In the optical image capturing system 10 of the first embodiment, the second lens 120, the third lens 130 and the sixth lens 160 have negative refractive power. The coefficient of dispersion of the second lens 120 may be expressed as NA2. The coefficient of dispersion of the third lens 130 may be expressed as NA3. The coefficient of dispersion of the sixth lens 160 may be expressed as NA6. The following condition is satisfied: NA6/NA2≤1. Therefore, this configuration is helpful to correct the chromatic aberration of the optical image capturing system.

In the optical image capturing system 10 of the first embodiment, TV distortion and optical distortion for image formation in the optical image capturing system 10 may be respectively expressed as TDT and ODT. The following conditions are satisfied: |TDT|=2.124% and |ODT|=5.076%.

In the optical image capturing system 10 of the present embodiment, the modulation transfer rates (values of MTF) for the visible light at the spatial frequency of 55 cycles/mm at positions of the optical axis, 0.3 HOI and 0.7 HOI on the image plane are denoted as MTFE0, MTFE3 and MTFE7 respectively. The following conditions are satisfied: MTFE0 is about 0.84, MTFE3 is about 0.84 and MTFE7 is about 0.75. The modulation transfer rates (values of MTF) for the visible light at the spatial frequency of 110 cycles/mm at positions of the optical axis, 0.3 HOI and 0.7 HOI on the image plane 190 are respectively denoted as MTFQ0, MTFQ3 and MTFQ7. The following conditions are satisfied: MTFQ0 is about 0.66, MTFQ3 is about 0.65 and MTFQ7 is about 0.51. The modulation transfer rates (values of MTF) for the visible light at the spatial frequency of 220 cycles/mm at positions of the optical axis, 0.3 HOI and 0.7 HOI on the first image plane 190 are respectively denoted as MTFH0, MTFH3 and MTFH7. The following conditions are satisfied: MTFH0 is about 0.17, MTFH3 is about 0.07 and MTFH7 is about 0.14.

In the optical image capturing system 10 of the present embodiment, when the operation wavelength 850 nm focuses on the image plane 190, the modulation transfer rates (MTF values) with the spatial frequency of 55 cycles/mm where the images are at the optical axis, 0.3 field of view and 0.7 field of view are respectively expressed as MTFI0, MTFI3 and MTFI7. The following conditions are satisfied: MTFI0 is about 0.81, MTFI3 is about 0.8 and MTFI7 is about 0.15.

Please refer to the following Table 1 and Table 2.

The detailed data of the optical image capturing system 10 of the first embodiment is as shown in Table 1.

TABLE 1
Lens Parameters for the First Embodiment
f (focal length) = 4.075 mm; f/HEP = 1.4;
HAF (half angle of view) = 50.000 deg

| | | | Thickness | |
|---|---|---|---|---|
| Surface No | Curvature Radius | | (mm) | Material |
| 0 | Object | Plane | Plane | |
| 1 | First Lens | −40.99625704 | 1.934 | Plastic |
| 2 | | 4.555209289 | 5.923 | |
| 3 | Aperture | Plane | 0.495 | |
| 4 | Second Lens | 5.333427366 | 2.486 | Plastic |
| 5 | | −6.781659971 | 0.502 | |
| 6 | Third Lens | −5.697794287 | 0.380 | Plastic |
| 7 | | −8.883957518 | 0.401 | |
| 8 | Fourth Lens | 13.19225664 | 1.236 | Plastic |
| 9 | | 21.55681832 | 0.025 | |
| 10 | Fifth Lens | 8.987806345 | 1.072 | Plastic |
| 11 | | −3.158875374 | 0.025 | |
| 12 | Sixth Lens | −29.46491425 | 1.031 | Plastic |
| 13 | | 3.593484273 | 2.412 | |
| 14 | IR-bandstop filter | Plane | 0.200 | |
| 15 | | Plane | 1.420 | |
| 16 | First Image Plane | Plane | | |

| Surface No | Refractive Index | Coefficient of Dispersion | Focal Length |
|---|---|---|---|
| 0 | | | |
| 1 | 1.515 | 56.55 | −7.828 |
| 2 | | | |
| 3 | | | |
| 4 | 1.544 | 55.96 | 5.897 |
| 5 | | | |
| 6 | 1.642 | 22.46 | −25.738 |
| 7 | | | |
| 8 | 1.544 | 55.96 | 59.205 |
| 9 | | | |
| 10 | 1.515 | 56.55 | 4.668 |
| 11 | | | |
| 12 | 1.642 | 22.46 | −4.886 |
| 13 | | | |
| 14 | 1.517 | 64.13 | |
| 15 | | | |
| 16 | | | |

Reference Wavelength = 555 nm. Shield Position: the 1st surface with effective aperture radius = 5.800 mm; the 3rd surface with effective aperture radius = 1.570 mm; the 5th surface with effective aperture radius = 1.950 mm

As for the parameters of the aspheric surfaces of the first embodiment, reference is made to Table 2.

TABLE 2
Aspheric Coefficients

| | Surface No | | | |
|---|---|---|---|---|
| | 1 | 2 | 4 | 5 |
| k | 4.310876E+01 | −4.707622E+00 | 2.616025E+00 | 2.445397E+00 |
| A4 | 7.054243E−03 | 1.714312E−02 | −8.377541E−03 | −1.789549E−02 |
| A6 | −5.233264E−04 | −1.502232E−04 | −1.838068E−03 | −3.657520E−03 |
| A8 | 3.077890E−05 | −1.359611E−04 | 1.233332E−03 | −1.131622E−03 |
| A10 | −1.260650E−06 | 2.680747E−05 | −2.390895E−03 | 1.390351E−03 |
| A12 | 3.319093E−08 | −2.017491E−06 | 1.998555E−03 | −4.152857E−04 |
| A14 | −5.051600E−10 | 6.604615E−08 | −9.734019E−04 | 5.487286E−05 |
| A16 | 3.380000E−12 | −1.301630E−09 | 2.478373E−04 | −2.919339E−06 |
| | Surface No | | | |
| | 6 | 7 | 8 | 9 |
| k | 5.645686E+00 | −2.117147E+01 | −5.287220E+00 | 6.200000E+01 |
| A4 | −3.379055E−03 | −1.370959E−02 | −2.937377E−02 | −1.359965E−01 |
| A6 | −1.225453E−03 | 6.250200E−03 | 2.743532E−03 | 6.628518E−02 |
| A8 | −5.979572E−03 | −5.854426E−03 | −2.457574E−03 | −2.129167E−02 |
| A10 | 4.556449E−03 | 4.049451E−03 | 1.874319E−03 | 4.396344E−03 |
| A12 | −1.177175E−03 | −1.314592E−03 | −6.013661E−04 | −5.542899E−04 |
| A14 | 1.370522E−04 | 2.143097E−04 | 8.792480E−05 | 3.768879E−05 |
| A16 | −5.974015E−06 | −1.399894E−05 | −4.770527E−06 | −1.052467E−06 |
| | Surface No | | | |
| | 10 | 11 | 12 | 13 |
| k | −2.114008E+01 | −7.699904E+00 | −6.155476E+01 | −3.120467E−01 |
| A4 | −1.263831E−01 | −1.927804E−02 | −2.492467E−02 | −3.521844E−02 |
| A6 | 6.965399E−02 | 2.478376E−03 | −1.835360E−03 | 5.629654E−03 |
| A8 | −2.116027E−02 | 1.438785E−03 | 3.201343E−03 | −5.466925E−04 |
| A10 | 3.819371E−03 | −7.013749E−04 | −8.990757E−04 | 2.231154E−05 |
| A12 | −4.040283E−04 | 1.253214E−04 | 1.245343E−04 | 5.548990E−07 |
| A14 | 2.280473E−05 | −9.943196E−06 | −8.788363E−06 | −9.396920E−08 |
| A16 | −5.165452E−07 | 2.898397E−07 | 2.494302E−07 | 2.728360E−09 |

Table 1 is the detailed structure data to the first embodiment in FIG. 1A, wherein the unit of the curvature radius, the thickness, the distance, and the focal length is millimeters (mm) Surfaces 0-16 illustrate the surfaces from the object side to the image plane in the optical image capturing system. Table 2 is the aspheric coefficients of the first embodiment, wherein k is the conic coefficient in the aspheric surface formula, and A1-A20 are the first to the twentieth order aspheric surface coefficient. Furthermore, the tables in the following embodiments are respectively referenced to the schematic view and the aberration graphs, and definitions of parameters in the tables are equal to those in the Table 1 and the Table 2, so the repetitious details will not be given here.

### The Second Embodiment (Embodiment 2)

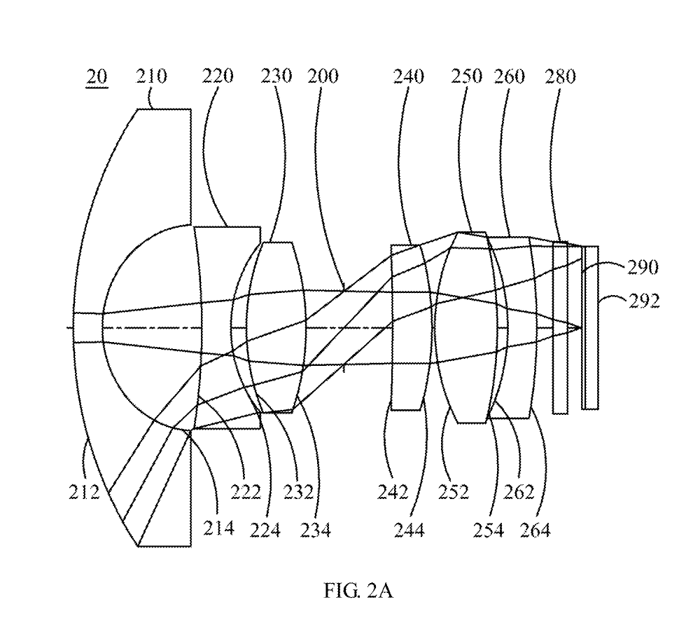

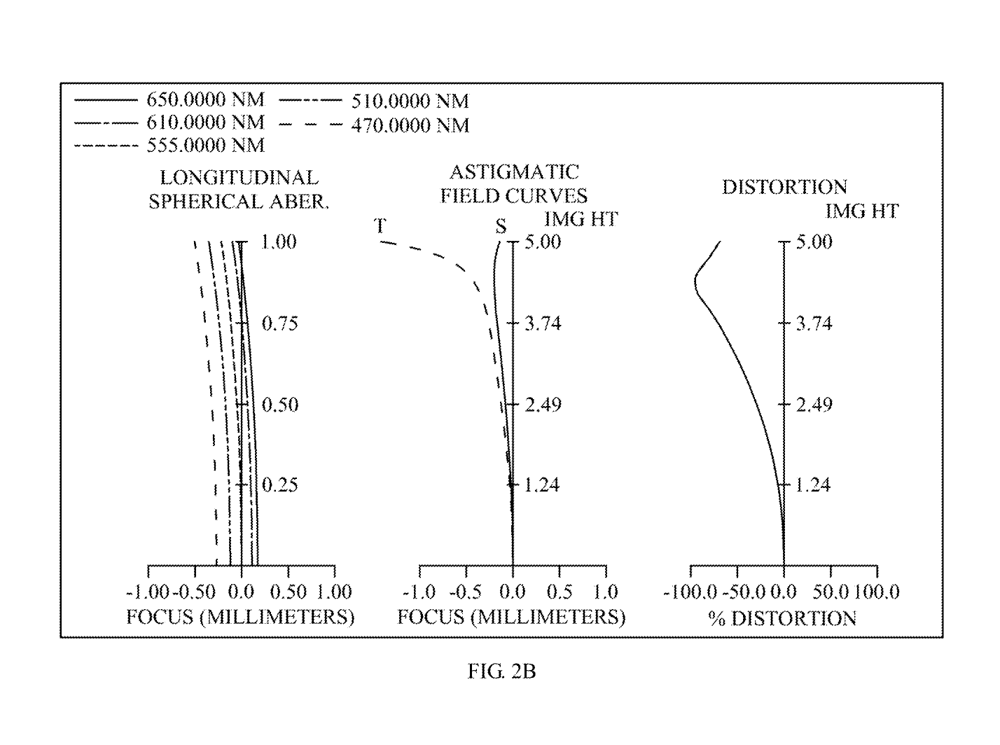

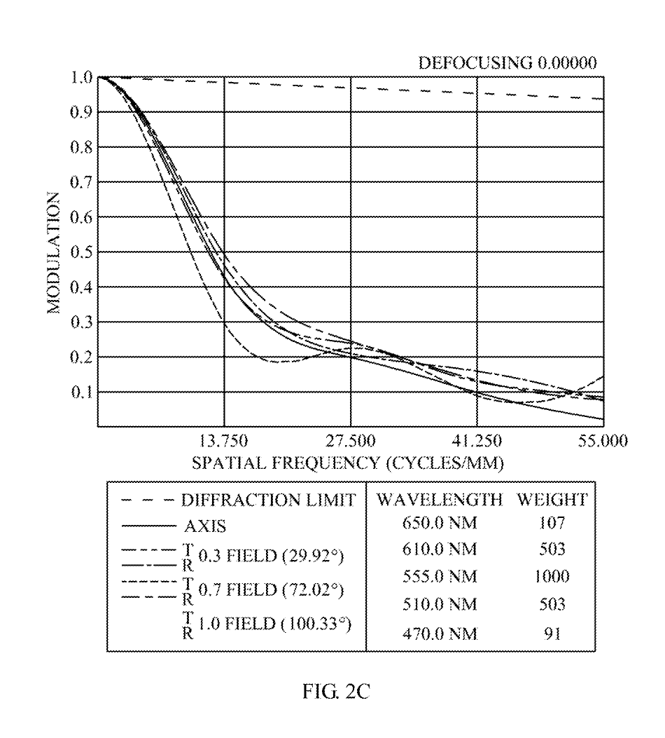

Please refer to FIG. 2A, FIG. 2B and FIG. 2C. FIG. 2A is a schematic view of the optical image capturing system according to the second embodiment of the present application. FIG. 2B is longitudinal spherical aberration curves, astigmatic field curves, and an optical distortion curve of the optical image capturing system in the order from left to right according to the second embodiment of the present application. FIG. 2C is a characteristic diagram of modulation transfer of the visible light spectrum according to the second embodiment of the present invention. As shown in FIG. 2A, in order from an object side to an image side, the optical image capturing system 20 includes a first lens 210, a second lens 220, a third lens 230, an aperture stop 200, a fourth lens 240, a fifth lens 250, a sixth lens 260, an IR-bandstop filter 280, an image plane 290, and an image sensing device 292.

The first lens 210 has negative refractive power and is made of glass. The first lens 210 has a convex object side 212 and a concave image side 214. Both of the object side 212 and the image side 214 of the first lens 210 are spherical.

The second lens 220 has negative refractive power and is made of glass. The second lens 220 has a concave object side 222 and a concave image side 224. Both of the object side 222 and the image side 224 of the second lens 220 are spherical.

The third lens 230 has positive refractive power and is made of glass. The third lens 230 has a convex object side 232 and a convex image side 234. Both of the object side 232 and the image side 234 of the third lens 230 are spherical.

The fourth lens 240 has positive refractive power and is made of glass. The fourth lens 240 has a concave object side 242 and a convex image side 244. Both of the object side 242 and the image side 244 of the fourth lens 240 are spherical.

The fifth lens 250 has positive refractive power and is made of glass. The fifth lens 250 has a convex object side 252 and a convex image side 254. Both of the object side 252 and the image side 254 of the fifth lens 250 are spherical.

The sixth lens 260 has negative refractive power and is made of glass. The sixth lens 260 has a concave object side 262 and a convex image side 264. Both of the object side 262 and the image side 264 of the sixth lens 260 are spherical. Hereby, the back focal length is reduced to miniaturize the lens effectively. In addition, the angle of incident with incoming light from an off-axis field of view can be suppressed effectively and the aberration in the off-axis field of view can be corrected further.

The IR-bandstop filter 280 is made of glass without affecting the focal length f of the optical image capturing system 20 and disposed between the sixth lens 260 and the image plane 290.

Please refer to the following Table 3 and Table 4.

The detailed data of the optical image capturing system 20 of the second embodiment is as shown in Table 3.

TABLE 3
Lens Parameters for the First Embodiment
f (focal length) = 2.944 mm; f/HEP = 1.6;
HAF (half angle of view) = 100 deg

| Surface No | Curvature Radius | | Thickness (mm) | Material |
|---|---|---|---|---|
| 0 | Object | 1E+18 | 1E+18 | |
| 1 | First Lens | 22.93525274 | 2.000 | Glass |
| 2 | | 6.385577732 | 6.842 | |
| 3 | Second Lens | −37.66765484 | 2.000 | Glass |
| 4 | | 7.769637136 | 1.076 | |
| 5 | Third Lens | 12.60854892 | 4.100 | Glass |
| 6 | | −14.64734886 | 2.615 | |
| 7 | Aperture | 1E+18 | 3.334 | |
| 8 | Fourth Lens | −116.9176455 | 2.713 | Glass |
| 9 | | −16.59684295 | 0.200 | |
| 10 | Fifth Lens | 11.8226766 | 4.300 | Glass |
| 11 | | −22.2558827 | 0.721 | |
| 12 | Sixth Lens | −11.76450909 | 2.000 | Glass |
| 13 | | −29.62702073 | 1.100 | |
| 14 | IR-bandstop | 1E+18 | 1.000 | BK_7 |
| | filter | | | |
| 15 | | 1E+18 | 1.000 | |
| 16 | Image Plane | 1E+18 | 0.000 | |

| Surface No | Refractive Index | Coefficient of Dispersion | Focal Length |
|---|---|---|---|
| 0 | | | |
| 1 | 2.001 | 29.13 | −9.35336 |
| 2 | | | |
| 3 | 1.702 | 41.15 | −8.9776 |
| 4 | | | |
| 5 | 1.946 | 17.98 | 7.65529 |
| 6 | | | |
| 7 | | | |
| 8 | 2.001 | 29.13 | 18.9472 |
| 9 | | | |
| 10 | 2.001 | 29.13 | 8.1841 |
| 11 | | | |
| 12 | 1.946 | 17.98 | −21.6072 |
| 13 | | | |
| 14 | 1.517 | 64.13 | |
| 15 | | | |
| 16 | | | |

Reference Wavelength = 555 nm

As for the parameters of the aspheric surfaces of the second embodiment, reference is made to Table 4.

TABLE 4
Aspheric Coefficients

| | Surface No. | | | |
|---|---|---|---|---|
| | 1 | 2 | 3 | 4 |
| k | 0.000000E+00 | 0.000000E+00 | 0.000000E+00 | 0.000000E+00 |
| A4 | 0.000000E+00 | 0.000000E+00 | 0.000000E+00 | 0.000000E+00 |
| A6 | 0.000000E+00 | 0.000000E+00 | 0.000000E+00 | 0.000000E+00 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |
| | Surface No. | | | |
| | 5 | 6 | 8 | 9 |
| k | 0.000000E+00 | 0.000000E+00 | 0.000000E+00 | 0.000000E+00 |
| A4 | 0.000000E+00 | 0.000000E+00 | 0.000000E+00 | 0.000000E+00 |
| A6 | 0.000000E+00 | 0.000000E+00 | 0.000000E+00 | 0.000000E+00 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |
| | Surface No. | | | |
| | 10 | 11 | 12 | 13 |
| k | 0.000000E+00 | 0.000000E+00 | 0.000000E+00 | 0.000000E+00 |
| A4 | 0.000000E+00 | 0.000000E+00 | 0.000000E+00 | 0.000000E+00 |
| A6 | 0.000000E+00 | 0.000000E+00 | 0.000000E+00 | 0.000000E+00 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |

In the second embodiment, the presentation of the aspheric surface equation is similar to that in the first embodiment. Besides, the definitions of parameters in following tables are similar to those in the first embodiment, so the repetitive details will not be given here.

The following values for the conditions can be obtained from the data in Table 3 and Table 4.

Second Embodiment (Primary Reference Wavelength = 555 nm)

| MTFE0 | MTFE3 | MTFE7 | | | |
|---|---|---|---|---|---|
| 0.03 | 0.09 | 0.15 | | | |
| ETP1 | ETP2 | ETP3 | ETP4 | ETP5 | ETP6 |
| 2.048 | 2.066 | 4.037 | 2.691 | 4.245 | 2.022 |
| ETP1/TP1 | ETP2/TP2 | ETP3/TP3 | ETP4/TP4 | ETP5/TP5 | ETP6/TP6 |
| 1.024 | 1.033 | 0.985 | 0.992 | 0.987 | 1.011 |
| ETL | EBL | EIN | EIR | PIR | EIN/ETL |
| 34.982 | 3.114 | 31.868 | 1.114 | 1.100 | 0.911 |
| SETP/EIN | EIR/PIR | SETP | STP | SETP/STP | BL |
| 0.537 | 1.013 | 17.109 | 17.113 | 1.000 | 3.100 |
| ED12 | ED23 | ED34 | ED45 | ED56 | EBL/BL |
| 6.764 | 1.055 | 5.974 | 0.261 | 0.704 | 1.0045 |
| SED | SIN | SED/SIN | ED12/ED23 | ED23/ED34 | ED34/ED45 |
| 14.758 | 14.787 | 0.998 | 6.413 | 0.177 | 22.856 |
| ED12/IN12 | ED23/IN23 | ED34/IN34 | ED45/IN45 | ED56/IN56 | ED45/ED56 |
| 0.989 | 0.980 | 1.004 | 1.307 | 0.976 | 0.372 |
| \|f/f1\| | \|f/f2\| | \|f/f3\| | \|f/f4\| | \|f/f5\| | \|f/f6\| |
| 0.31481 | 0.32798 | 0.38463 | 0.15541 | 0.35978 | 0.13627 |
| | | ΣPPR/ | | | TP4/ |
| ΣPPR | ΣNPR | \|ΣNPR\| | IN12/f | IN56/f | (IN34 + TP4 + IN45) |
| 0.67631 | 1.00257 | 0.67458 | 2.32368 | 0.24471 | 0.30614 |
| \|f1/f2\| | \|f2/f3\| | (TP1 + IN12)/TP2 | | (TP6 + IN56)/TP5 | |
| 1.04186 | 1.17273 | 4.42102 | | 0.63269 | |
| HOS | InTL | HOS/HOI | InS/HOS | ODT % | TDT % |
| 35.00030 | 31.90040 | 7.00006 | 0.46762 | −128.98900 | 86.54440 |
| HVT51 | HVT52 | HVT61 | HVT62 | HVT62/HOI | HVT62/HOS |
| 0 | 0 | 0 | 0 | 0 | 0 |
| TP2/TP3 | TP3/TP4 | InRS61 | InRS62 | \|InRS61\|/TP6 | \|InRS62\|/TP6 |
| 0.48781 | 1.51118 | −1.39856 | −0.53153 | 0.69928 | 0.26576 |

The following values for the conditional expressions can be obtained from the data in Table 3 and Table 4.

Values Related to Inflection Point of Second Embodiment
(Primary Reference Wavelength = 555 nm)

| | | | | | | | |
|---|---|---|---|---|---|---|---|
| HIF311 | 0 | HIF311/ | 0 | SGI311 | 0 | \| SGI311 \|/ | 0 |
| | | HOI | | | | (\| SGI311 \| +TP3) | |

### Third Embodiment

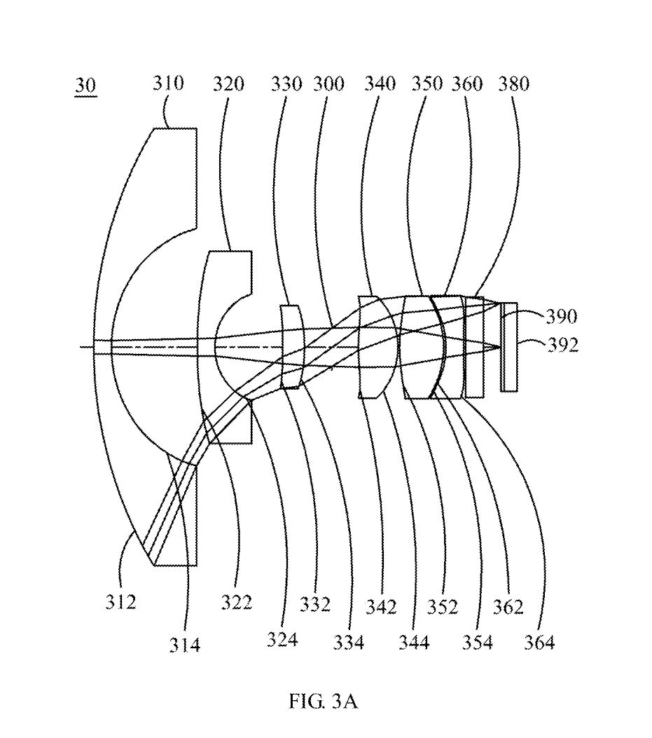

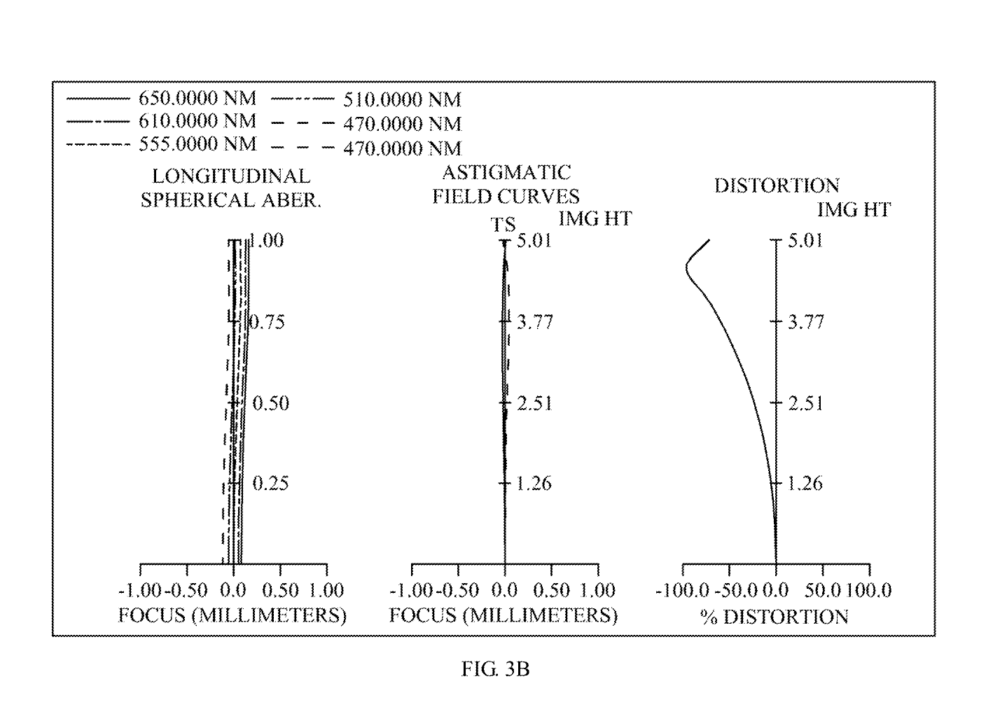

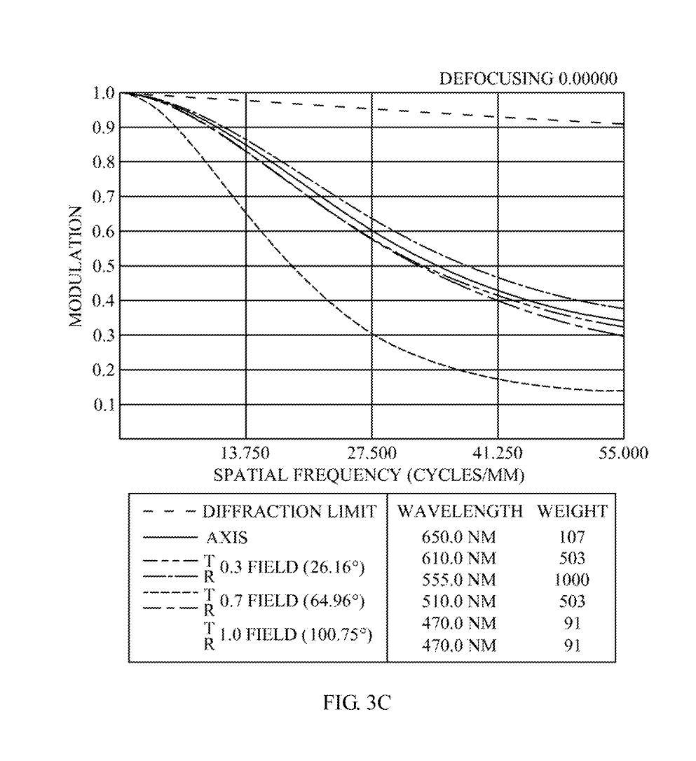

Please refer to FIG. 3A, FIG. 3B and FIG. 3C. FIG. 3A is a schematic view of the optical image capturing system according to the third embodiment of the present invention. FIG. 3B shows the longitudinal spherical aberration curves, astigmatic field curves, and optical distortion curve of the optical image capturing system, in the order from left to right, according to the third embodiment of the present invention. FIG. 3C is a characteristic diagram of modulation transfer of the visible light spectrum according to the third embodiment of the present invention. As shown in FIG. 3A, in order from an object side to an image side, the optical image capturing system 30 includes a first lens 310, a second lens 320, a third lens 330, an aperture stop 300, a fourth lens 340, a fifth lens 350, a sixth lens 360, an IR-bandstop filter 380, an image plane 390, and an image sensing device 392.

The first lens 310 has negative refractive power and is made of glass. The first lens 310 has a convex object side 312 and a concave image side 314. Both of the object side 312 and the image side 314 of the first lens 310 are spherical.

The second lens 320 has negative refractive power and is made of plastic. The second lens 320 has a convex object side 322 and a concave image side 324. Both of the object side 322 and the image side 324 of the second lens 320 are aspheric.

The third lens 330 has positive refractive power and is made of plastic. The third lens 330 has a concave object side 332 and a convex image side 334. Both of the object side 332 and the image side 334 are aspheric of the third lens 330.

The fourth lens 340 has positive refractive power and is made of plastic. The fourth lens 340 has a convex object side 342 and a convex image side 344. Both of the object side 342 and the image side 344 of the fourth lens 340 are aspheric. The object side 342 of the fourth lens 340 has one inflection point.

The fifth lens 350 has positive refractive power and is made of plastic. The fifth lens 350 has a convex object side 352 and a convex image side 354. Both of the object side 352 and the image side 354 of the fifth lens 350 are aspheric. The object side 352 of the fifth lens 350 has one inflection point.

The sixth lens 360 has negative refractive power and is made of plastic. The sixth lens 360 has a concave object side 362 and a concave image side 364. Both of the object side 362 and the image side 364 of the sixth lens 360 are aspheric. The image side 364 of the sixth lens 360 has one inflection point. Hereby, the back focal length is reduced to miniaturize the lens effectively. In addition, the angle of incident with incoming light from an off-axis field of view can be suppressed effectively and the aberration in the off-axis field of view can be corrected further.

The IR-bandstop filter 380 is made of glass without affecting the focal length f of the optical image capturing system 30 and disposed between the sixth lens 360 and the image plane 390.

Please refer to the following Table 5 and Table 6.

The detailed data of the optical image capturing system 30 of the third embodiment is as shown in Table 5.

TABLE 5
Lens Parameter for the Third Embodiment
f (focal length) = 3.35107 mm; f/HEP = 2.4; HAF (angle
of view) = 100 deg

| Surface | | | | |
|---|---|---|---|---|
| No. | Curvature Radius | | Thickness (mm) | Material |
| 0 | Object | 1E+18 | 1E+18 | |
| 1 | First Lens | 39.94985664 | 2.000 | Glass |
| 2 | | 12.42460758 | 9.753 | |
| 3 | Second Lens | 47.08888977 | 2.000 | Plastic |
| 4 | | 5.607047528 | 7.675 | |
| 5 | Third Lens | −127.6810996 | 2.483 | Plastic |
| 6 | | −14.92898044 | 3.138 | |
| 7 | Aperture | 1E+18 | 2.989 | |
| 8 | Fourth lens | 18.93168536 | 4.476 | Plastic |
| 9 | | −6.97588396 | 0.200 | |
| 10 | Fifth Lens | 15.82841812 | 4.999 | Plastic |
| 11 | | −8.11091021 | 0.269 | |
| 12 | Sixth Lens | −6.660991145 | 2.000 | Plastic |
| 13 | | 49.91282791 | 0.234 | |
| 14 | IR-bandstop Filter | 1E+18 | 2.000 | BK_7 |
| 15 | | 1E+18 | 1.999 | |
| 16 | First Image Plane | 1E+18 | 0.000 | |

| Surface No. | Refractive Index | Coefficient of Dispersion | Focal Length |
|---|---|---|---|
| 0 | | | |
| 1 | 1.569 | 56.04 | −32.4558 |
| 2 | | | |
| 3 | 1.544 | 55.96 | −11.8642 |
| 4 | | | |
| 5 | 1.661 | 20.40 | 25.132 |
| 6 | | | |
| 7 | | | |
| 8 | 1.544 | 55.96 | 9.94678 |
| 9 | | | |
| 10 | 1.544 | 55.96 | 10.6082 |
| 11 | | | |
| 12 | 1.661 | 20.40 | −8.69042 |
| 13 | | | |
| 14 | 1.517 | 64.13 | |
| 15 | | | |
| 16 | | | |

Reference Wavelength = 555 nm. Shield Position: the 9th surface with effective aperture radius = 5.200 mm

As for the parameters of the aspheric surfaces of the third embodiment, reference is made to Table 6.

TABLE 6
Aspheric Coefficients

| | Surface No. | | | |
|---|---|---|---|---|
| | 1 | 2 | 3 | 4 |
| k | 0.000000E+00 | 0.000000E+00 | 0.000000E+00 | 0.000000E+00 |
| A4 | 0.000000E+00 | 0.000000E+00 | 3.866442E−05 | −2.388756E−05 |
| A6 | 0.000000E+00 | 0.000000E+00 | 0.000000E+00 | 0.000000E+00 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |
| | Surface No. | | | |
| | 5 | 6 | 8 | 9 |
| k | 0.000000E+00 | 0.000000E+00 | 0.000000E+00 | 0.000000E+00 |
| A4 | −5.775440E−04 | −3.696774E−04 | −9.809135E−04 | −1.389221E−04 |
| A6 | 0.000000E+00 | 0.000000E+00 | 0.000000E+00 | 0.000000E+00 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |
| | Surface No. | | | |
| | 10 | 11 | 12 | 13 |
| k | 0.000000E+00 | 0.000000E+00 | 0.000000E+00 | 0.000000E+00 |
| A4 | −3.194411E−04 | 2.496154E−04 | 8.851249E−04 | −7.253515E−04 |
| A6 | 0.000000E+00 | 0.000000E+00 | 2.117052E−06 | −3.624906E−06 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |

The presentation of the aspheric surface formula in the third embodiment is similar to that in the first embodiment. Furthermore, the definitions of parameters in following tables are equal to those in the first embodiment so the repetitious details will not be given here.

The following values for the conditional expressions can be obtained from the data in Table 5 and Table 6.

Third Embodiment (Primary Reference Wavelength = 555 nm)

| MTFE0 | MTFE3 | MTFE7 | | | |
|---|---|---|---|---|---|
| 0.34 | 0.33 | 0.14 | | | |
| ETP1 | ETP2 | ETP3 | ETP4 | ETP5 | ETP6 |
| 2.014 | 2.038 | 2.468 | 4.428 | 4.953 | 2.041 |
| ETP1/TP1 | ETP2/TP2 | ETP3/TP3 | ETP4/TP4 | ETP5/TP5 | ETP6/TP6 |
| 1.007 | 1.019 | 0.994 | 0.989 | 0.991 | 1.021 |
| ETL | EBL | EIN | EIR | PIR | EIN/ETL |
| 46.208 | 4.228 | 41.980 | 0.229 | 0.234 | 0.908 |
| SETP/EIN | EIR/PIR | SETP | STP | SETP/STP | BL |
| 0.427 | 0.980 | 17.943 | 17.957 | 0.995 | 4.233 |
| ED12 | ED23 | ED34 | ED45 | ED56 | EBL/BL |
| 9.738 | 7.629 | 6.156 | 0.250 | 0.263 | 0.9988 |
| SED | SIN | SED/SIN | ED12/ED23 | ED23/ED34 | ED34/ED45 |
| 24.037 | 24.024 | 1.001 | 1.276 | 1.239 | 24.587 |
| ED12/IN12 | ED23/IN23 | ED34/IN34 | ED45/IN45 | ED56/IN56 | ED45/ED56 |
| 0.999 | 0.994 | 1.005 | 1.252 | 0.976 | 0.952 |
| \|f/f1\| | \|f/f2\| | \|f/f3\| | \|f/f4\| | \|f/f5\| | \|f/f6\| |
| 0.10325 | 0.28245 | 0.13334 | 0.33690 | 0.31589 | 0.38561 |
| | | ΣPPR/ | | | TP4/ |
| ΣPPR | ΣNPR | \|ΣNPR\| | IN12/f | IN56/f | (IN34 + TP4 + IN45) |
| 0.47024 | 0.90465 | 0.51980 | 2.91035 | 0.08042 | 0.41433 |
| \|f1/f2\| | \|f2/f3\| | (TP1 + IN12)/TP2 | | (TP6 + IN56)/TP5 | |
| 2.73561 | 0.47208 | 5.87640 | | 0.45401 | |
| HOS | InTL | HOS/HOI | InS/HOS | ODT % | TDT % |
| 46.21430 | 41.98130 | 9.24286 | 0.41472 | −124.90200 | 90.10600 |
| HVT51 | HVT52 | HVT61 | HVT62 | HVT62/HOI | HVT62/HOS |
| 0 | 0 | 0 | 2.56691 | 0.51338 | 0.05554 |
| TP2/TP3 | TP3/TP4 | InRS61 | InRS62 | \|InRS61\|/TP6 | \|InRS62\|/TP6 |
| 0.80563 | 0.55463 | −2.37135 | −1.14781 | 1.18568 | 0.57391 |

The following values for the conditional expressions can be obtained from the data in Table 5 and Table 6.

Values Related to Inflection Point of Third Embodiment
(Primary Reference Wavelength = 555 nm)

| | | | | | | | |
|---|---|---|---|---|---|---|---|
| HIF411 | 2.1390 | HIF411/ | 0.4278 | SGI411 | 0.1007 | \| SGI411 \|/ | 0.0220 |
| | | HOI | | | | (\| SGI411 \| +TP4) | |
| HIF511 | 4.2998 | HIF511/ | 0.8600 | SGI511 | 0.4860 | \| SGI511 \|/ | 0.0886 |
| | | HOI | | | | (\| SGI511 \| +TP5) | |
| HIF621 | 1.4976 | HIF621/ | 0.2995 | SGI621 | 0.0188 | \| SGI621 \|/ | 0.0093 |
| | | HOI | | | | (\| SGI621 \| +TP6) | |

### The Fourth Embodiment (Embodiment 4)

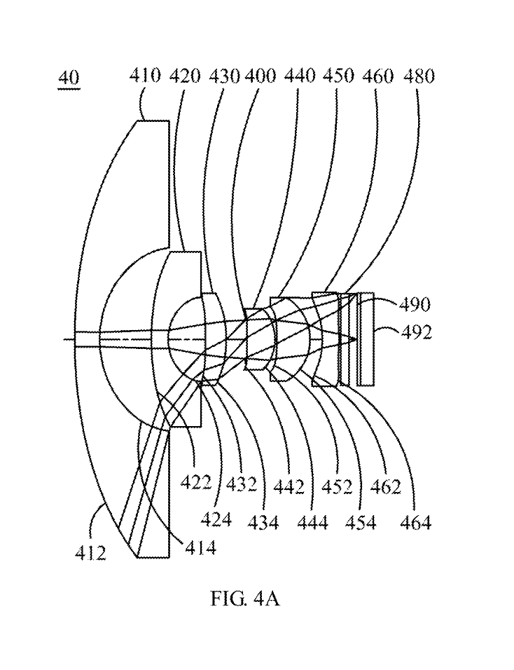

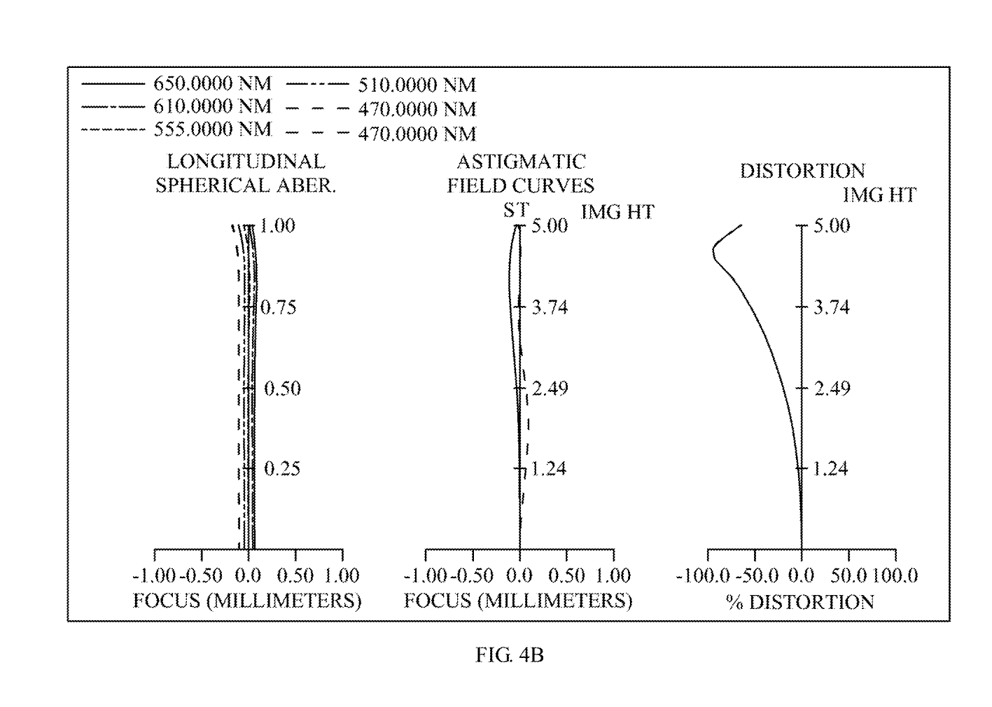

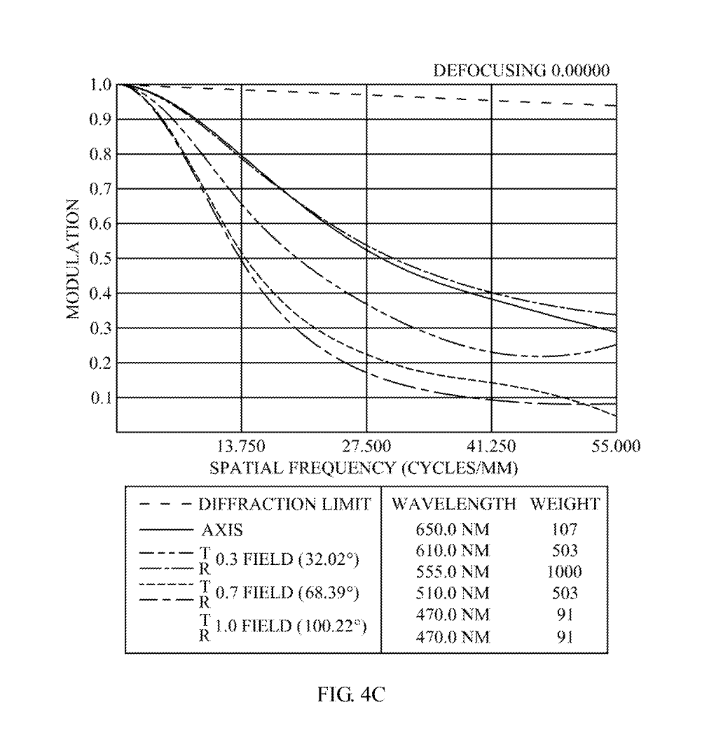

Please refer to FIG. 4A, FIG. 4B and FIG. 4C. FIG. 4A is a schematic view of the optical image capturing system according to the fourth embodiment of the present application. FIG. 4B is longitudinal spherical aberration curves, astigmatic field curves, and an optical distortion curve of the optical image capturing system in the order from left to right according to the fourth embodiment of the present application. FIG. 4C is a characteristic diagram of modulation transfer of the visible light spectrum according to the fourth embodiment of the present invention. As shown in FIG. 4A, in order from an object side to an image side, the optical image capturing system 40 includes a first lens 410, a second lens 420, a third lens 430, an aperture stop 400, a fourth lens 440, a fifth lens 450, a sixth lens 460, an IR-bandstop filter 480, an image plane 490, and an image sensing device 492.

The first lens 410 has negative refractive power and is made of glass. The first lens 410 has a convex object side 412 and a concave image side 414. Both of the object side 412 and the image side 414 of the first lens 410 are aspheric.

The second lens 420 has negative refractive power and is made of glass. The second lens 420 has a convex object side 422 and a concave image side 424.

The third lens 430 has positive refractive power and is made of plastic. The third lens 430 has a concave object side 432 and a convex image side 434. Both of the object side 432 and the image side 434 of the third lens 430 are aspheric.

The fourth lens 440 has positive refractive power and is made of plastic. The fourth lens 440 has a convex object side 442 and a convex image side 444. Both of the object side 442 and the image side 444 of the fourth lens 440 are aspheric. The object side 442 of the fourth lens 440 has one inflection point.

The fifth lens 450 has positive refractive power and is made of plastic. The fifth lens 450 has a concave object side 452 and a convex image side 454. Both of the object side 452 and the image side 454 of the fifth lens 450 are aspheric.

The sixth lens 460 has negative refractive power and is made of plastic. The sixth lens 460 has a concave object side 462 and a convex image side 464. Both of the object side 462 and the image side 464 of the sixth lens 460 are aspheric. Both of the object side 462 and the image side 464 of the sixth lens 460 have one inflection point. Hereby, the back focal length is reduced to miniaturize the lens effectively. In addition, the angle of incident with incoming light from an off-axis field of view can be suppressed effectively and the aberration in the off-axis field of view can be corrected further.

The IR-bandstop filter 480 is made of glass without affecting the focal length f of the optical image capturing system 40 and disposed between the sixth lens 460 and the image plane 490.

Please refer to the following Table 7 and Table 8.

The detailed data of the optical image capturing system 40 of the fourth embodiment is as shown in Table 7.

TABLE 7
Lens Parameter for the Fourth Embodiment
f (focal length) = 2.569 mm; f/HEP = 1.6; HAF (half angle
of view) = 100 deg

| Surface | | | | |
|---|---|---|---|---|
| No. | Curvature Radius | | Thickness (mm) | Material |
| 0 | Object | 1E+18 | 1E+18 | |
| 1 | First Lens | 49.92672093 | 3.000 | Glass |
| 2 | | 10.04111694 | 6.229 | |
| 3 | Second Lens | 28.50882066 | 2.000 | Glass |
| 4 | | 4.580587029 | 4.492 | |
| 5 | Third Lens | −74.59269543 | 2.514 | Plastic |
| 6 | | −10.53575566 | 2.262 | |
| 7 | Aperture | 1E+18 | 0.200 | |
| 8 | Fourth Lens | 53.33909086 | 3.403 | Plastic |
| 9 | | −4.48113123 | 0.200 | |
| 10 | Fifth Lens | −63.54302117 | 4.000 | Plastic |
| 11 | | −5.104197728 | 1.501 | |
| 12 | Sixth Lens | −7.323708482 | 2.000 | Plastic |
| 13 | | −15.0381441 | 0.200 | |
| 14 | IR-bandstop filter | 1E+18 | 1.000 | BK_7 |
| 15 | | 1E+18 | 1.000 | |
| 16 | First Image Plane | 1E+18 | 0.000 | |

| Surface No. | Refractive Index | Coefficient of Dispersion | Focal Length |
|---|---|---|---|
| 0 | | | |
| 1 | 1.497 | 81.56 | −25.8747 |
| 2 | | | |
| 3 | 1.658 | 50.85 | −8.54302 |
| 4 | | | |
| 5 | 1.661 | 20.40 | 18.1148 |
| 6 | | | |
| 7 | | | |
| 8 | 1.544 | 55.96 | 7.73499 |
| 9 | | | |
| 10 | 1.544 | 55.96 | 9.92909 |
| 11 | | | |
| 12 | 1.661 | 20.40 | −23.8879 |
| 13 | | | |
| 14 | 1.517 | 64.13 | |
| 15 | | | |
| 16 | | | |

Reference Wavelength: 555 nm

As for the parameters of the aspheric surfaces of the fourth embodiment, reference is made to Table 8.

TABLE 8
Aspheric Coefficients

| | Surface No | | | |
|---|---|---|---|---|
| | 1 | 2 | 3 | 4 |
| k | −5.599750E−02 | 0.000000E+00 | 0.000000E+00 | 0.000000E+00 |
| A4 | 4.982519E−06 | −7.194333E−05 | 9.910379E−05 | −1.210585E−04 |
| A6 | −2.385092E−10 | 2.867405E−07 | −2.286001E−07 | −3.079038E−05 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |
| | Surface No | | | |
| | 5 | 6 | 8 | 9 |
| k | 0.000000E+00 | 0.000000E+00 | 0.000000E+00 | 0.000000E+00 |
| A4 | −9.725400E−04 | −4.654417E−05 | −1.088150E−03 | 6.109066E−04 |
| A6 | 1.577310E−05 | −1.381477E−06 | −2.262930E−04 | −8.275311E−05 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |
| | Surface No | | | |
| | 10 | 11 | 12 | 13 |
| k | 0.000000E+00 | 0.000000E+00 | 1.000000E+00 | −1.452399E+00 |
| A4 | −2.297770E−03 | −1.019769E−03 | 1.733632E−04 | 4.800351E−03 |
| A6 | −1.594923E−04 | 4.179094E−05 | 6.689039E−05 | −2.237145E−04 |
| A8 | 0.000000E+00 | 0.000000E+00 | 0.000000E+00 | 2.674459E−06 |
| A10 | 0.000000E+00 | 0.000000E+00 | 0.000000E+00 | 0.000000E+00 |

The presentation of the aspheric surface formula in the fourth embodiment is similar to that in the first embodiment. Furthermore the definitions of parameters in following tables are equal to those in the first embodiment so the repetitious details will not be given here.

The following values for the conditional expressions can be obtained from the data in Table 7 and Table 8.

Fourth Embodiment (Primary Reference Wavelength = 555 nm)

| MTFE0 | MTFE3 | MTFE7 | | | |
|---|---|---|---|---|---|
| 0.87 | 0.86 | 0.65 | | | |
| ETP1 | ETP2 | ETP3 | ETP4 | ETP5 | ETP6 |
| 3.026 | 2.059 | 2.488 | 3.325 | 3.942 | 2.025 |
| ETP1/TP1 | ETP2/TP2 | ETP3/TP3 | ETP4/TP4 | ETP5/TP5 | ETP6/TP6 |
| 1.009 | 1.030 | 0.990 | 0.977 | 0.986 | 1.012 |
| ETL | EBL | EIN | EIR | PIR | EIN/ETL |
| 33.994 | 2.219 | 31.775 | 0.219 | 0.200 | 0.935 |
| SETP/EIN | EIR/PIR | SETP | STP | SETP/STP | BL |
| 0.531 | 1.097 | 16.865 | 16.917 | 0.997 | 2.199 |
| ED12 | ED23 | ED34 | ED45 | ED56 | EBL/BL |
| 6.208 | 4.416 | 2.498 | 0.266 | 1.521 | 1.0091 |
| SED | SIN | SED/SIN | ED12/ED23 | ED23/ED34 | ED34/ED45 |
| 14.910 | 14.884 | 1.002 | 1.406 | 1.768 | 9.385 |
| ED12/IN12 | ED23/IN23 | ED34/IN34 | ED45/IN45 | ED56/IN56 | ED45/ED56 |
| 0.997 | 0.983 | 1.015 | 1.331 | 1.013 | 0.175 |
| \|f/f1\| | \|f/f2\| | \|f/f3\| | \|f/f4\| | \|f/f5\| | \|f/f6\| |
| 0.09928 | 0.30070 | 0.14181 | 0.33211 | 0.25872 | 0.10754 |
| | | ΣPPR/ | | | TP4/ |
| ΣPPR | ΣNPR | \|ΣNPR\| | IN12/f | IN56/f | (IN34 + TP4 + IN45) |
| 1.10978 | 0.39998 | 2.77458 | 2.42467 | 0.58441 | 0.56108 |
| \|f1/f2\| | \|f2/f3\| | (TP1 + IN12)/TP2 | | (TP6 + IN56)/TP5 | |
| 3.02875 | 0.47160 | 4.61434 | | 0.87533 | |
| HOS | InTL | HOS/HOI | InS/HOS | ODT % | TDT % |
| 34.00040 | 31.80100 | 6.80008 | 0.39716 | −133.30700 | 102.49700 |
| HVT51 | HVT52 | HVT61 | HVT62 | HVT62/HOI | HVT62/HOS |
| 0 | 0 | 0 | 0 | 0 | 0 |
| | | | | \|InRS61\|/ | |
| TP2/TP3 | TP3/TP4 | InRS61 | InRS62 | TP6 | \|InRS62\|/TP6 |
| 0.79550 | 0.73880 | −1.21273 | −0.25003 | 0.60637 | 0.12501 |

The following values for the conditional expressions can be obtained from the data in Table 7 and Table 8.

Values Related to Inflection Point of fourth Embodiment
(Primary Reference Wavelength = 555 nm)

| | | | | | | | |
|---|---|---|---|---|---|---|---|
| HIF411 | 3.8336 | HIF411/ | 0.9880 | SGI411 | 1.1104 | \| SGI411 \|/ | 0.2339 |
| | | HOI | | | | (\| SGI411 \| +TP4) | |
| HIF611 | 3.6354 | HIF611/ | 0.7271 | SGI611 | −0.8693 | \| SGI611 \|/ | 0.3030 |
| | | HOI | | | | (\| SGI611 \| +TP6) | |
| HIF612 | 4.1175 | HIF612/ | 0.8235 | SGI612 | −1.0652 | \| SGI612 \|/ | 0.3475 |
| | | HOI | | | | (\| SGI612 \| +TP6) | |
| HIF621 | 1.1655 | HIF621/ | 0.2331 | SGI621 | −0.0368 | \| SGI621 \|/ | 0.0181 |
| | | HOI | | | | (\| SGI621 \| +TP6) | |
| HIF622 | 3.1109 | HIF622/ | 0.6222 | SGI622 | −0.0500 | \| SGI622 \|/ | 0.0244 |
| | | HOI | | | | (\| SGI622 \| +TP6) | |

### The Fifth Embodiment (Embodiment 5)

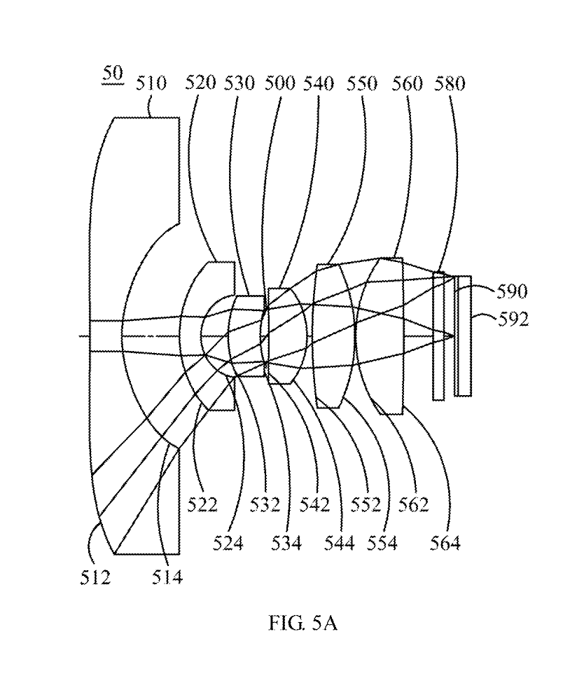

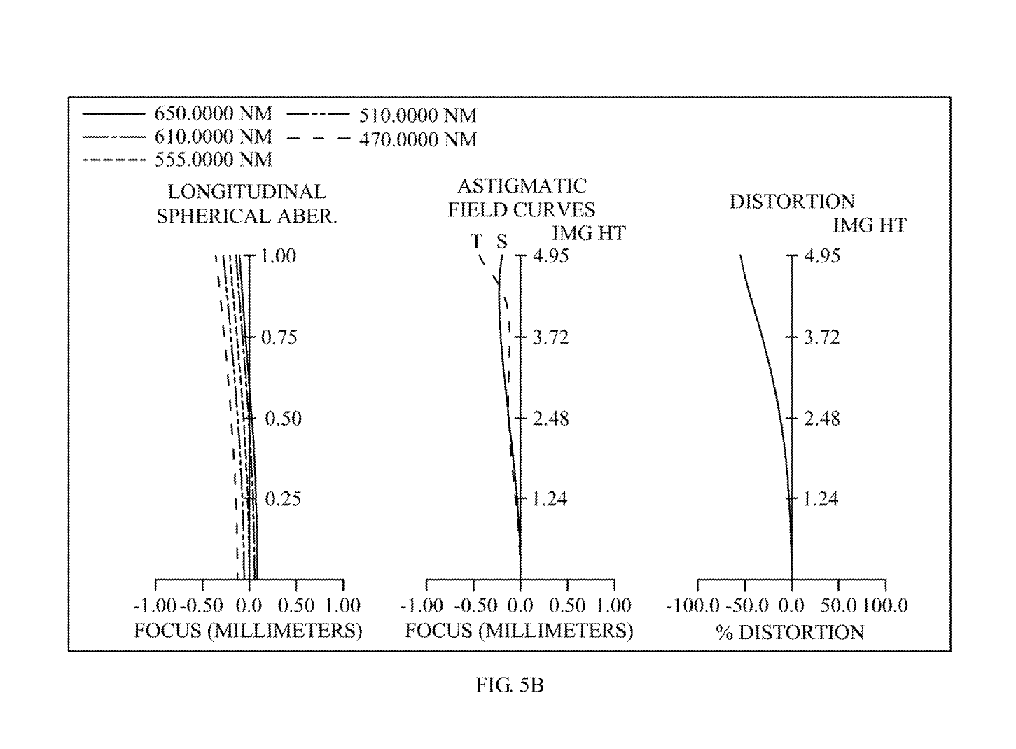

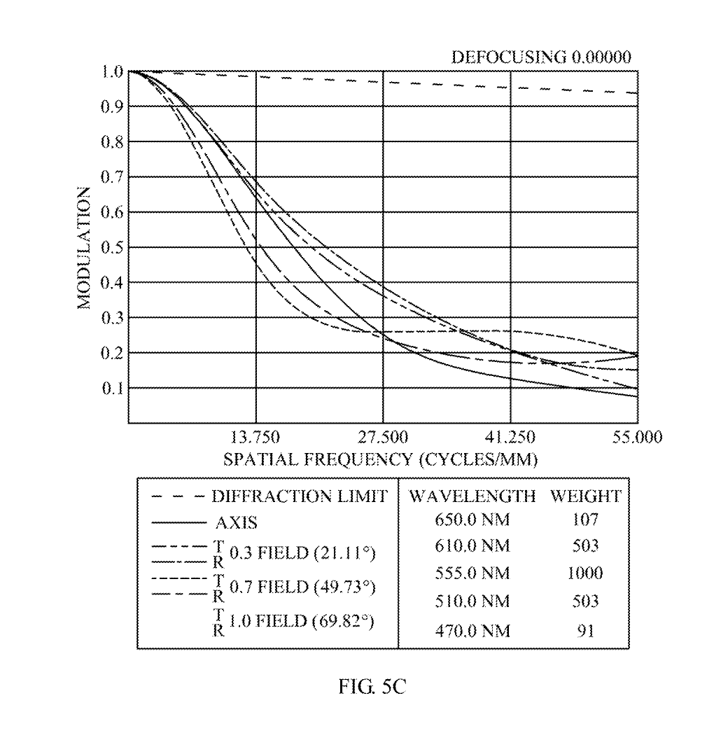

Please refer to FIG. 5A, FIG. 5B and FIG. 5C. FIG. 5A is a schematic view of the optical image capturing system according to the fifth embodiment of the present application. FIG. 5B is longitudinal spherical aberration curves, astigmatic field curves, and an optical distortion curve of the optical image capturing system in the order from left to right according to the fifth embodiment of the present application. FIG. 5C is a characteristic diagram of modulation transfer of the visible light spectrum according to the fifth embodiment of the present invention. As shown in FIG. 5A, in order from an object side to an image side, the optical image capturing system 50 includes a first lens 510, a second lens 520, a third lens 530, an aperture stop 500, a fourth lens 540, a fifth lens 550, a sixth lens 560, an IR-bandstop filter 580, an image plane 590, and an image sensing device 592.

The first lens 510 has negative refractive power and is made of glass. The first lens 510 has a concave object side 512 and a concave image side 514. Both of the object side 512 and the image side 514 of the first lens 510 are aspheric. The object side 512 of the first lens 510 has one inflection point.

The second lens 520 has negative refractive power and is made of glass. The second lens 520 has a convex object side 522 and a concave image side 524. Both of the object side 522 and the image side 524 of the second lens 520 are spherical.

The third lens 530 has positive refractive power and is made of glass. The third lens 530 has a convex object side 532 and a concave image side 534. Both of the object side 532 and the image side 534 of the third lens 530 are spherical.

The fourth lens 540 has positive refractive power and is made of glass. The fourth lens 540 has a concave object side 542 and a convex image side 544. Both of the object side 542 and the image side 544 of the fourth lens 540 are spherical.

The fifth lens 550 has positive refractive power and is made of glass. The fifth lens 550 has a convex object side 552 and a convex image side 554. Both of the object side 552 and the image side 554 of the fifth lens 550 are spherical.

The sixth lens 560 has positive refractive power and is made of plastic. The sixth lens 560 has a convex object side 562 and a convex image side 564. Both of the object side 562 and the image side 564 of the sixth lens 560 are spherical. Hereby, the back focal length is reduced to miniaturize the lens effectively. In addition, the angle of incident with incoming light from an off-axis field of view can be suppressed effectively and the aberration in the off-axis field of view can be corrected further.

The IR-bandstop filter 580 is made of glass without affecting the focal length of the optical image capturing system and disposed between the sixth lens 560 and the image plane 590.

Please refer to the following Table 9 and Table 10.

The detailed data of the optical image capturing system 50 of the fifth embodiment is as shown in Table 9.

TABLE 9
Lens Parameters for the Fifth Embodiment
f (focal length) = 4.077 mm; f/HEP = 1.6; HAF (half angle
of view) = 70 deg

| Surface | | | | |
|---|---|---|---|---|
| No | Curvature Radius | | Thickness (mm) | Material |
| 0 | Object | 1E+18 | 1E+18 | |
| 1 | First Lens | −285.4847192 | 3.000 | Glass |
| 2 | | 9.915511784 | 5.360 | |
| 3 | Second Lens | 8.520966112 | 2.000 | Glass |
| 4 | | 3.455512823 | 2.539 | |
| 5 | Third Lens | 7.345536924 | 3.000 | Glass |
| 6 | | 7.496148199 | 0.554 | |
| 7 | Aperture | 1E+18 | 0.224 | |
| 8 | Fourth Lens | −143.1264978 | 3.571 | Glass |
| 9 | | −5.87925421 | 0.490 | |
| 10 | Fifth Lens | 38.83261522 | 3.972 | Glass |
| 11 | | −12.58712249 | 0.081 | |
| 12 | Sixth Lens | 10.53263983 | 4.465 | Glass |
| 13 | | −200.0200003 | 2.745 | |
| 14 | IR-bandstop | 1E+18 | 1.000 | BK_7 |
| | filter | | | |
| 15 | | 1E+18 | 1.000 | |
| 16 | First Image | 1E+18 | 0.000 | |
| | Plane | | | |

| Surface No | Refractive Index | Coefficient of Dispersion | Focal Length |
|---|---|---|---|
| 0 | | | |
| 1 | 1.497 | 81.56 | −19.169 |
| 2 | | | |
| 3 | 1.553 | 71.68 | −12.197 |
| 4 | | | |
| 5 | 2.002 | 19.32 | 32.835 |
| 6 | | | |
| 7 | | | |
| 8 | 1.569 | 56.04 | 10.643 |
| 9 | | | |
| 10 | 1.569 | 56.04 | 17.138 |
| 11 | | | |
| 12 | 1.497 | 81.56 | 20.226 |
| 13 | | | |
| 14 | 1.517 | 64.13 | |
| 15 | | | |
| 16 | | | |

Reference Wavelength (d-line): 555 nm

As for the parameters of the aspheric surfaces of the fifth embodiment, reference is made to Table 10.

TABLE 10
Aspheric Coefficients

| | Surface No | | | |
|---|---|---|---|---|
| | 1 | 2 | 3 | 4 |
| k | 0.000000E+00 | 0.000000E+00 | 0.000000E+00 | 0.000000E+00 |
| A4 | 2.230590E−05 | −2.186554E−04 | 0.000000E+00 | 0.000000E+00 |
| A6 | 9.869022E−09 | 3.286427E−07 | 0.000000E+00 | 0.000000E+00 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |
| | Surface No | | | |
| | 5 | 6 | 8 | 9 |
| k | 0.000000E+00 | 0.000000E+00 | 0.000000E+00 | 0.000000E+00 |
| A4 | 0.000000E+00 | 0.000000E+00 | 0.000000E+00 | 0.000000E+00 |
| A6 | 0.000000E+00 | 0.000000E+00 | 0.000000E+00 | 0.000000E+00 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |
| | Surface No | | | |
| | 10 | 11 | 12 | 13 |
| k | 0.000000E+00 | 0.000000E+00 | 0.000000E+00 | 0.000000E+00 |
| A4 | 0.000000E+00 | 0.000000E+00 | 0.000000E+00 | 0.000000E+00 |
| A6 | 0.000000E+00 | 0.000000E+00 | 0.000000E+00 | 0.000000E+00 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |

The presentation of the aspheric surface formula in the fifth embodiment is similar to that in the first embodiment. Furthermore the definitions of parameters in following tables are equal to those in the first embodiment so the repetitious details will not be given here.

The following values for the conditional expressions can be obtained from the data in Table 9 and Table 10.

Fifth Embodiment (Primary Reference Wavelength = 555 nm)

| MTFE0 | MTFE3 | MTFE7 | | | |
|---|---|---|---|---|---|
| 0.08 | 0.1 | 0.19 | | | |
| ETP1 | ETP2 | ETP3 | ETP4 | ETP5 | ETP6 |
| 3.084 | 2.148 | 2.998 | 3.436 | 3.886 | 4.384 |
| ETP1/TP1 | ETP2/TP2 | ETP3/TP3 | ETP4/TP4 | ETP5/TP5 | ETP6/TP6 |
| 1.028 | 1.074 | 0.999 | 0.962 | 0.978 | 0.982 |
| ETL | EBL | EIN | EIR | PIR | EIN/ETL |
| 34.003 | 4.749 | 29.254 | 2.749 | 2.745 | 0.860 |
| SETP/EIN | EIR/PIR | SETP | STP | SETP/STP | BL |
| 0.681 | 1.001 | 19.936 | 20.007 | 0.996 | 4.745 |
| ED12 | ED23 | ED34 | ED45 | ED56 | EBL/BL |
| 5.374 | 2.407 | 0.663 | 0.651 | 0.223 | 1.0008 |
| SED | SIN | SED/SIN | ED12/ED23 | ED23/ED34 | ED34/ED45 |
| 9.317 | 9.247 | 1.008 | 2.233 | 3.633 | 1.018 |
| ED12/IN12 | ED23/IN23 | ED34/IN34 | ED45/IN45 | ED56/IN56 | ED45/ED56 |
| 1.003 | 0.948 | 0.852 | 1.328 | 2.755 | 2.919 |
| \|f/f1\| | \|f/f2\| | \|f/f3\| | \|f/f4\| | \|f/f5\| | \|f/f6\| |
| 0.21270 | 0.33429 | 0.12417 | 0.38309 | 0.23790 | 0.20159 |
| | | ΣPPR/ | | | TP4/ |
| ΣPPR | ΣNPR | \|ΣNPR\| | IN12/f | IN56/f | (IN34 + TP4 + IN45) |
| 0.70886 | 0.78489 | 0.90313 | 1.31464 | 0.01984 | 0.73803 |
| \|f1/f2\| | \|f2/f3\| | (TP1 + IN12)/TP2 | | (TP6 + IN56)/TP5 | |
| 1.57165 | 0.37146 | 4.17990 | | 1.14460 | |
| HOS | InTL | HOS/HOI | InS/HOS | ODT % | TDT % |
| 34.00000 | 29.25490 | 6.80000 | 0.51611 | −54.89250 | 35.91980 |
| HVT51 | HVT52 | HVT61 | HVT62 | HVT62/HOI | HVT62/HOS |
| 0 | 0 | 0 | 0 | 0 | 0 |
| | | | | \|InRS61\|/ | |
| TP2/TP3 | TP3/TP4 | InRS61 | InRS62 | TP6 | \|InRS62\|/TP6 |
| 0.66667 | 0.84022 | 2.27978 | −0.09567 | 0.51055 | 0.02143 |

The following values for the conditional expressions can be obtained from the data in Table 9 and Table 10.

Values Related to Inflection Point of Fifth Embodiment
(Primary Reference Wavelength = 555 nm)

| | | | | | | | |
|---|---|---|---|---|---|---|---|
| HIF111 | 3.5923 | HIF111/ | 0.7185 | SGI111 | −0.0189 | \| SGI111 \|/ | 0.0063 |
| | | HOI | | | | (\| SGI111 \| +TP1) | |

### The Sixth Embodiment (Embodiment 6)

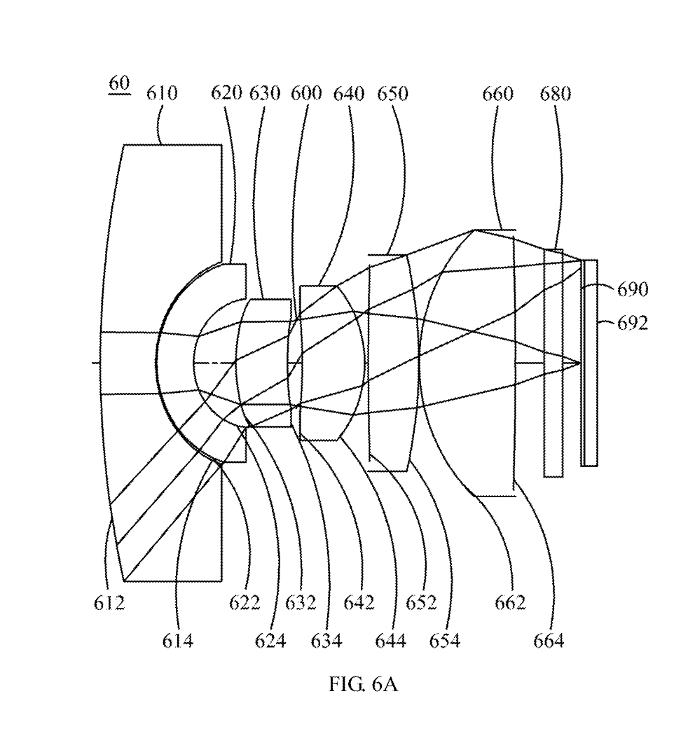

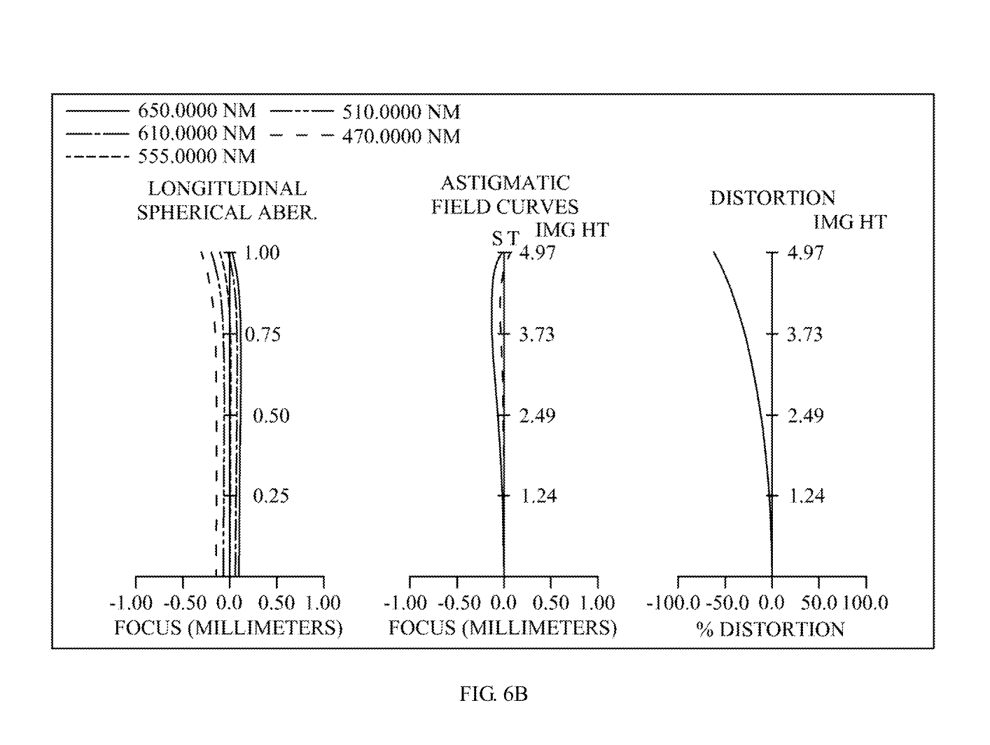

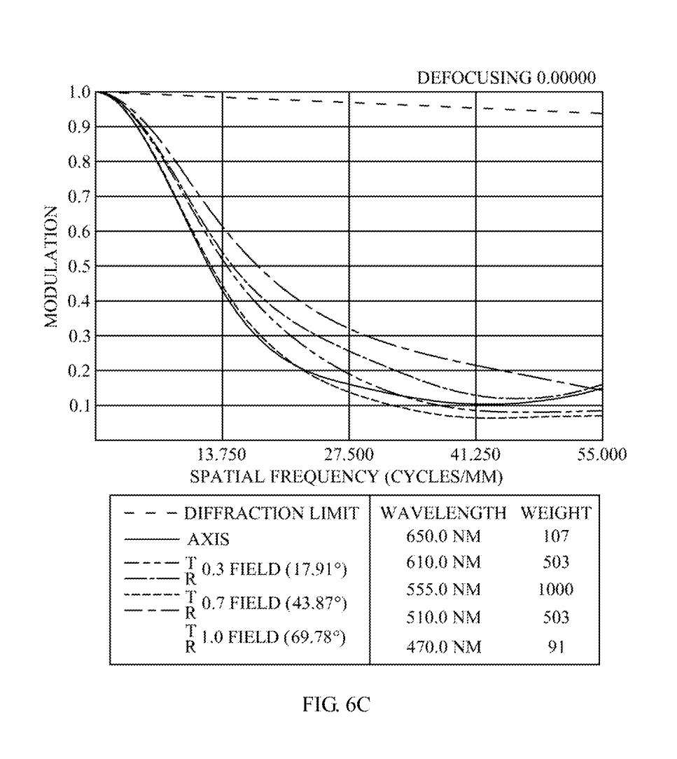

Please refer to FIG. 6A, FIG. 6B and FIG. 6C. FIG. 6A is a schematic view of the optical image capturing system according to the sixth Embodiment of the present application. FIG. 6B is longitudinal spherical aberration curves, astigmatic field curves, and an optical distortion curve of the optical image capturing system in the order from left to right according to the sixth Embodiment of the present application. FIG. 6C is a characteristic diagram of modulation transfer of the visible light spectrum according to the fifth embodiment of the present invention. As shown in FIG. 6A, in order from an object side to an image side, the optical image capturing system 60 includes a first lens 610, a second lens 620, a third lens 630, an aperture stop 600, a fourth lens 640, a fifth lens 650, a sixth lens 660, an IR-bandstop filter 680, an image plane 690, and an image sensing device 692.

The first lens 610 has negative refractive power and is made of glass. The first lens 610 has a convex object side 612 and a concave image side 614. Both of the object side 612 and the image side 614 of the first lens 610 are spherical.

The second lens 620 has negative refractive power and is made of glass. The second lens 620 has a convex object side 622 and a concave image side 624. Both of the object side 622 and the image side 624 of the second lens 620 are spherical.

The third lens 630 has positive refractive power and is made of glass. The third lens 630 has a concave object side 632 and a convex image side 634. Both of the object side 632 and the image side 634 of the third lens 630 are aspheric.

The fourth lens 640 has positive refractive power and is made of glass material. The fourth lens 640 has a concave object side 642 and a convex image side 644. Both of the object side 642 and the image side 644 of the fourth lens 640 are spherical.

The fifth lens 650 has positive refractive power and is made of glass. The fifth lens 650 has a convex object side 652 and a convex image side 654. Both of the object side 652 and the image side 654 of the fifth lens 650 are spherical.

The sixth lens 660 has positive refractive power and is made of glass. The sixth lens 660 has a convex object side 662 and a convex image side 664. Both of the object side 662 and the image side 664 of the sixth lens 660 are spherical. Hereby, the back focal length is reduced to miniaturize the lens effectively. In addition, the angle of incident with incoming light from an off-axis field of view can be suppressed effectively and the aberration in the off-axis field of view can be corrected further.

The IR-bandstop filter 680 is made of glass without affecting the focal length f of the optical image capturing system 60 and disposed between the sixth lens 660 and the image plane 690.

Please refer to the following Table 11 and Table 12.

The detailed data of the optical image capturing system 60 of the sixth Embodiment is as shown in Table 11.

TABLE 11
Lens Parameters for the Sixth Embodiment
f (focal length) = 4.866 mm; f/HEP = 1.6; HAF (half angle
of view) = 70 deg

| Surface | | | | |
|---|---|---|---|---|
| No | Curvature Radius | | Thickness (mm) | Material |
| 0 | Object | 1E+18 | 1E+18 | |
| 1 | First Lens | 44.9660633 | 2.999 | Glass |
| 2 | | 5.211415802 | 0.050 | |
| 3 | Second Lens | 5.032302116 | 2.000 | Glass |
| 4 | | 3.153145731 | 2.280 | |
| 5 | Third Lens | 8.0641139 | 2.797 | Glass |
| 6 | | 19.80167808 | 0.477 | |
| 7 | Aperture | 1E+18 | 0.325 | |
| 8 | Fourth Lens | −22.78279237 | 3.364 | Glass |
| 9 | | −5.473580879 | 0.200 | |
| 10 | Fifth Lens | 156.6630309 | 2.732 | Glass |
| 11 | | −21.5579582 | 0.025 | |
| 12 | Sixth Lens | 8.578963147 | 5.200 | Glass |
| 13 | | −200.021581 | 1.551 | |
| 14 | IR-bandstop filter | 1E+18 | 1.000 | BK_7 |
| 15 | | 1E+18 | 1.000 | |
| 16 | First Image Plane | 1E+18 | 0.000 | |

| Surface No | Refractive Index | Coefficient of Dispersion | Focal Length |
|---|---|---|---|
| 0 | | | |
| 1 | 1.497 | 81.56 | −12.135615 |
| 2 | | | |
| 3 | 2.002 | 19.32 | −17.964289 |
| 4 | | | |
| 5 | 1.923 | 20.88 | 13.110025 |
| 6 | | | |
| 7 | | | |
| 8 | 1.723 | 37.99 | 9.162113 |
| 9 | | | |
| 10 | 1.497 | 81.56 | 10.5601 |
| 11 | | | |
| 12 | 1.497 | 81.56 | 12.9841 |
| 13 | | | |
| 14 | 1.517 | 64.13 | |
| 15 | | | |
| 16 | | | |

Reference Wavelength: 555 nm

As for the parameters of the aspheric surfaces of the sixth Embodiment, reference is made to Table 12.

TABLE 12
Aspheric Coefficients

| | Surface No | | | |
|---|---|---|---|---|
| | 1 | 2 | 3 | 4 |
| k | 0.000000E+00 | 0.000000E+00 | 0.000000E+00 | 0.000000E+00 |
| A4 | 0.000000E+00 | 0.000000E+00 | 0.000000E+00 | 0.000000E+00 |
| A6 | 0.000000E+00 | 0.000000E+00 | 0.000000E+00 | 0.000000E+00 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |
| | Surface No | | | |
| | 5 | 6 | 8 | 9 |
| k | 0.000000E+00 | 0.000000E+00 | 0.000000E+00 | 0.000000E+00 |
| A4 | 4.389446E−04 | 1.693160E−03 | 0.000000E+00 | 0.000000E+00 |
| A6 | 1.256058E−04 | 9.810560E−05 | 0.000000E+00 | 0.000000E+00 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |
| | Surface No | | | |
| | 10 | 11 | 12 | 13 |
| k | 0.000000E+00 | 0.000000E+00 | 0.000000E+00 | 0.000000E+00 |
| A4 | 0.000000E+00 | 0.000000E+00 | 0.000000E+00 | 0.000000E+00 |
| A6 | 0.000000E+00 | 0.000000E+00 | 0.000000E+00 | 0.000000E+00 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |

In the sixth Embodiment, the presentation of the aspheric surface formula is similar to that in the first embodiment. Furthermore, the definitions of parameters in following tables are equal to those in the first embodiment, so the repetitious details will not be given here.

The following values for the conditional expressions can be obtained from the data in Table 11 and Table 12.

Sixth Embodiment (Primary Reference Wavelength = 555 nm)

| MTFE0 | MTFE3 | MTFE7 | | | |
|---|---|---|---|---|---|
| 0.15 | 0.08 | 0.07 | | | |
| ETP1 | ETP2 | ETP3 | ETP4 | ETP5 | ETP6 |
| 3.200 | 2.156 | 2.718 | 3.199 | 2.670 | 5.058 |
| ETP1/TP1 | ETP2/TP2 | ETP3/TP3 | ETP4/TP4 | ETP5/TP5 | ETP6/TP6 |
| 1.067 | 1.078 | 0.971 | 0.951 | 0.978 | 0.973 |
| ETL | EBL | EIN | EIR | PIR | EIN/ETL |
| 25.975 | 3.557 | 22.418 | 1.557 | 1.551 | 0.863 |
| SETP/EIN | EIR/PIR | SETP | STP | SETP/STP | BL |
| 0.848 | 1.004 | 19.002 | 19.092 | 0.995 | 3.551 |
| ED12 | ED23 | ED34 | ED45 | ED56 | EBL/BL |
| 0.058 | 2.038 | 0.683 | 0.423 | 0.215 | 1.0017 |
| SED | SIN | SED/SIN | ED12/ED23 | ED23/ED34 | ED34/ED45 |
| 3.417 | 3.358 | 1.018 | 0.029 | 2.983 | 1.615 |
| ED12/IN12 | ED23/IN23 | ED34/IN34 | ED45/IN45 | ED56/IN56 | ED45/ED56 |
| 1.169 | 0.894 | 0.851 | 2.114 | 8.582 | 1.971 |
| \|f/f1\| | \|f/f2\| | \|f/f3\| | \|f/f4\| | \|f/f5\| | \|f/f6\| |
| 0.40098 | 0.27088 | 0.37118 | 0.53112 | 0.12729 | 0.29228 |
| | | ΣPPR/ | | | TP4/ |
| ΣPPR | ΣNPR | \|ΣNPR\| | IN12/f | IN56/f | (IN34 + TP4 + IN45) |
| 1.23117 | 0.67186 | 1.83247 | 0.01028 | 0.00514 | 0.77041 |
| \|f1/f2\| | \|f2/f3\| | (TP1 + IN12)/TP2 | | (TP6 + IN56)/TP5 | |
| 0.67554 | 1.37027 | 1.52445 | | 1.91286 | |
| HOS | InTL | HOS/HOI | InS/HOS | ODT % | TDT % |
| 26.00110 | 22.44970 | 5.20022 | 0.59219 | −62.13740 | 44.42730 |
| HVT51 | HVT52 | HVT61 | HVT62 | HVT62/HOI | HVT62/HOS |
| 0 | 0 | 0 | 0 | 0 | 0 |
| | | | | \|InRS61\|/ | |
| TP2/TP3 | TP3/TP4 | InRS61 | InRS62 | TP6 | \|InRS62\|/TP6 |
| 0.71496 | 0.83151 | 2.97389 | −0.09230 | 0.57189 | 0.01775 |

The following values for the conditional expressions can be obtained from the data in Table 11 and Table 12.

Values Related to Inflection Point of sixth Embodiment
(Primary Reference Wavelength = 555 nm)

| | | | | | | | |
|---|---|---|---|---|---|---|---|
| HIF411 | 0 | HIF411/ | 0 | SGI411 | 0 | \| SGI411 \|/ | 0 |
| | | HOI | | | | (\| SGI411 \| +TP4) | |

Although the present invention is disclosed via the aforementioned embodiments, those embodiments do not serve to limit the scope of the present invention. A person skilled in the art may perform various alterations and modifications to the present invention without departing from the spirit and the scope of the present invention. Hence, the scope of the present invention should be defined by the following appended claims.

Despite the fact that the present invention is specifically presented and illustrated with reference to the exemplary embodiments thereof, it should be obvious to a person skilled in the art that, various modifications to the forms and details of the present invention may be performed without departing from the scope and spirit of the present invention defined by the following claims and equivalents thereof.

What is claimed is:

1. An optical image capturing system, from an object side to an image side, comprising:
a first lens with refractive power;
a second lens with refractive power;
a third lens with refractive power;
a fourth lens with refractive power;
a fifth lens with refractive power;
a sixth lens with refractive power; and
an image plane;
wherein the optical image capturing system comprises the six lenses with refractive power and at least one lens among the six lenses is made of glass, a maximum height for image formation on the image plane perpendicular to an optical axis in the optical image capturing system is denoted by HOI, at least one lens among the first lens to the sixth lens has positive refractive power, focal lengths of the first lens through the sixth lens are respectively f1, f2, f3, f4, f5 and f6, a focal length of the optical image capturing system is f, the entrance pupil diameter of the optical image capturing system is HEP, a distance on an optical axis from an object side of the first lens to the image plane is HOS, a distance on an optical axis from the object side of the first lens to the image side of the sixth lens is InTL, a half maximum angle of view of the optical image capturing system is HAF, thicknesses of the first lens to the sixth lens at height of ½ HEP parallel to the optical axis are respectively expressed as ETP1, ETP2, ETP3, ETP4, ETP5 and ETP6, a sum of ETP1 to ETP6 described above is expressed as SETP, thicknesses of the first lens to the sixth lens on the optical axis are respectively expressed as TP1, TP2, TP3, ETP4, ETP5 and ETP6, a sum of TP1 to TP6 described above is expressed as STP, and the following conditions are satisfied: 1.0≤f/HEP≤10.0, 0 deg<HAF≤150 deg, 0.5≤HOS/f≤15, 0.5≤SETP/STP<1.

2. The optical image capturing system of claim 1, wherein the following relationship is satisfied: 0.5≤HOS/HOI≤10.

3. The optical image capturing system of claim 1, wherein a distance between the third lens and the fourth lens on the optical axis is IN34, a distance between the fourth lens and the fifth lens on the optical axis is IN45, and the following relationship is satisfied: IN34>IN45.

4. The optical image capturing system of claim 1, wherein a distance between the fourth lens and the fifth lens on the optical axis is IN45, a distance between the fifth lens and the sixth lens on the optical axis is IN56 and the following relationship is satisfied: IN45>In56.

5. The optical image capturing system of claim 1, wherein modulation transfer rates of visible light at spatial frequency of 55 cycles/mm at positions of the optical axis, 0.3 HOI and 0.7 HOI on the image plane are respectively expressed as MTFE0, MTFE3 and MTFE7, and the following conditions are satisfied: MTFE0≥0.2, MTFE3≥0.01, and MTFE7≥0.01.

6. The optical image capturing system of claim 1, wherein a horizontal distance parallel to the optical axis from a first coordinate point on the object side of the first lens at height of ½ HEP to the image plane is expressed as ETL, a horizontal distance parallel to the optical axis from the first coordinate point on the object side of the first lens at height of ½ HEP to a second coordinate point on the image side of the sixth lens at height of ½ HEP is expressed as EIN, and the following condition is satisfied: 0.2≤EIN/ETL<1.

7. The optical image capturing system of claim 2, wherein thicknesses of the first lens through the sixth lens at height of ½ HEP parallel to the optical axis are respectively expressed as ETP1, ETP2, ETP3, ETP4, ETP5 and ETP6, a sum of ETP1 to ETP6 described above is expressed as SETP, and the following conditions is satisfied: 0.3≤SETP/EIN<1.

8. The optical image capturing system of claim 1, wherein a horizontal distance parallel to the optical axis from a second coordinate point on the image side of the sixth lens at height of ½ HEP to the image plane is expressed as EBL, a horizontal distance parallel to the optical axis from an intersection point where the image side of the sixth lens crosses the optical axis to the image plane is expressed as BL, and the following condition is satisfied: 0.1≤EBL/BL≤1.1.

9. The optical image capturing system of claim 1, further comprising an aperture stop, a distance from the aperture stop to the image plane on the optical axis is InS, and the following relationship is satisfied: 0.1≤InS/HOS≤1.1.

10. An optical image capturing system, from an object side to an image side, comprising:
a first lens with negative refractive power;
a second lens with refractive power;
a third lens with refractive power;
a fourth lens with refractive power;
a fifth lens with refractive power;
a sixth lens with refractive power; and
an image plane;
wherein the optical image capturing system comprises the six lenses with refractive power, a maximum height for image formation on the image plane perpendicular to an optical axis in the optical image capturing system is denoted by HOI, at least two lenses among the first lens to the sixth lens are made of glass and at least one lens among the second lens to the sixth lens has positive refractive power, focal lengths of the first lens through the sixth lens are respectively f1, f2, f3, f4, f5 and f6, the focal length of the optical image capturing system is f, an entrance pupil diameter of the optical image capturing system is HEP, a distance on the optical axis from an object side of the first lens to the image plane is HOS, a distance on the optical axis from the object side of the first lens to an image side of the sixth lens is InTL, a half maximum angle of view of the optical image capturing system is HAF, a horizontal distance parallel to the optical axis from a first coordinate point on an object side of the first lens at height of ½ HEP to the image plane is expressed as ETL, a horizontal distance parallel to the optical axis from the first coordinate point on the object side of the first lens at height of ½ HEP to a second coordinate point on the image side of the sixth lens at height of ½ HEP is expressed as EIN, and the following conditions are satisfied: 1.0≤f/HEP≤10.0, 0 deg<HAF≤150 deg, 0.5≤HOS/f≤15, and 0.2≤EIN/ETL<1.

11. The optical image capturing system of claim 10, wherein modulation transfer rates of visible light at spatial frequency of 55 cycles/mm at positions of the optical axis, 0.3 HOI and 0.7 HOI on the image plane are respectively expressed as MTFE0, MTFE3 and MTFE7, and following conditions are satisfied: MTFE0≥0.2, MTFE3≥0.01, and MTFE7≥0.01.

12. The optical image capturing system of claim 10, wherein a horizontal distance parallel to the optical axis from a third coordinate point on an image side of the fifth lens at height of ½ HEP to a fourth coordinate point on an object side of the sixth lens at height of ½ HEP is expressed as ED56; a distance between the fifth lens and the sixth lens on the optical axis is expressed as IN56 and the condition as follows is satisfied: 0<ED56/IN56≤50.

13. The optical image capturing system of claim 10, wherein a horizontal distance parallel to the optical axis from a fifth coordinate point on an image side of the first lens at height of ½ HEP to a sixth coordinate point on an object side of the second lens at height of ½ HEP is expressed as ED12; a distance between the first lens and the second lens on the optical axis is expressed as IN12 and the following relationship is satisfied: 0<ED12/IN12<10.

14. The optical image capturing system of claim 10, wherein there is an air gap between each lens among the six lenses.

15. The optical image capturing system of claim 10, wherein a thickness of the fifth lens at height of ½ HEP parallel to the optical axis is expressed as ETP5, a thickness of the fifth lens on the optical axis is expressed as TP5, and the following relationship is satisfied: 0<ETP5/TP5≤3.

16. The optical image capturing system of claim 10, wherein a thickness of the sixth lens at height of ½ HEP parallel to the optical axis is expressed as ETP6, a thickness of the sixth lens on the optical axis is expressed as TP6, and the following relationship is satisfied: 0<ETP6/TP6≤5.

17. The optical image capturing system of claim 10, wherein a distance between the first lens and the second lens on the optical axis is IN12, and the following relationship is satisfied: 0<IN12/f≤60.

18. The optical image capturing system of claim 10, wherein the optical image capturing system comprises a light filtering element, the light filtering element is located between the sixth lens and the image plane, a distance parallel to the optical axis from a second coordinate point on the image side of the sixth lens at height of ½ HEP to the light filtering element is expressed as EIR, a distance parallel to the optical axis from an intersection point where the image side of the sixth lens crosses the optical axis to the light filtering is expressed as PIR, and the following condition is satisfied: 0.1≤EIR/PIR≤1.1.

19. The optical image capturing system of claim 10, wherein at least one lens among the first lens to the sixth lens is a light filtering element with a wavelength of less than 500 nm.

20. An optical image capturing system, from an object side to an image side, comprising:
a first lens with negative refractive power;
a second lens with negative refractive power;
a third lens with refractive power;
a fourth lens with refractive power;
a fifth lens with refractive power;
a sixth lens with refractive power; and
an image plane;
wherein the optical image capturing system comprises the six lenses with refractive power, a maximum height for image formation on the image plane perpendicular to an optical axis in the optical image capturing system is denoted by HOI, at least one lens among the first lens through the sixth lens is made of a glass; focal lengths of the first lens through the sixth lens are f1, f2, f3, f4, f5 and f6 respectively, a focal length of the optical image capturing system is f, an entrance pupil diameter of the optical image capturing system is HEP, a half maximum angle of view of the optical image capturing system is HAF, a distance on the optical axis from an object side of the first lens to the image plane is HOS, a distance on the optical axis from the object side of the first lens to an image side of the sixth lens is InTL, a horizontal distance parallel to the optical axis from a first coordinate point on the object side of the first lens at height of ½ HEP to the image plane is expressed as ETL, a horizontal distance parallel to the optical axis from the first coordinate point on the object side of the first lens at height of ½ HEP to a second coordinate point on the image side of the sixth lens at height of ½ HEP is expressed as EIN, and the following conditions are satisfied: 1.0 f/HEP≤10.0, 0 deg<HAF≤150 deg, 0.5≤HOS/f≤15, 0.5≤HOS/HOI≤10, and 0.2≤EIN/ETL<1.

21. The optical image capturing system of claim 20, wherein there is an air gap between each lens among the six lenses.

22. The optical image capturing system of claim 20, wherein a distance between the third lens and the fourth lens on the optical axis is IN34, a distance between the fourth lens and the fifth lens on the optical axis is IN45, and the following relationship is satisfied: IN34>IN45.

23. The optical image capturing system of claim 20, wherein a distance between the fourth lens and the fifth lens on the optical axis is IN45, a distance between the fifth lens and the sixth lens on the optical axis is IN56, and the following relationship is satisfied: IN45>IN56.

24. The optical image capturing system of claim 20, wherein modulation transfer rates of visible light at spatial frequency of 55 cycles/mm at positions of the optical axis, 0.3 HOI and 0.7 HOI on the image plane are respectively expressed as MTFE0, MTFE3 and MTFE7, and the following conditions are satisfied: MTFE0≥0.2, MTFE3≥0.01, and MTFE7≥0.01.

25. The optical image capturing system of claim 20, further comprising an aperture stop, an image sensing device and a driving module, wherein the image sensing device is disposed on the image plane, a distance on the optical axis from the aperture stop to the image plane is InS, and the driving module couples with the lenses to displace the lenses, and the following relationship is satisfied: 0.2≤InS/HOS≤1.1.
